(19) United States
(12) Patent Application Publication
(10) Pub. No.: US 2021/0046477 A1
(43) Pub. Date: Feb. 18, 2021

(54) RAPID AND HIGH-PRECISION SIZING OF SINGLE PARTICLES USING PARALLEL SUSPENDED MICROCHANNEL RESONATOR ARRAYS AND DECONVOLUTION

(71) Applicant: Massachusetts Institute of Technology, Cambridge, MA (US)

(72) Inventors: Scott R. Manalis, Portland, OR (US); Selim Olcum, Cambridge, MA (US); Robert J. Kimmerling, Cambridge, MA (US); Max Stockslager, Cumming, GA (US)

(73) Assignee: Massachusetts Institute of Technology, Cambridge, MA (US)

(21) Appl. No.: 16/901,924

(22) Filed: Jun. 15, 2020

Related U.S. Application Data
(60) Provisional application No. 62/925,883, filed on Oct. 25, 2019.
(60) Provisional application No. 62/887,504, filed on Aug. 15, 2019.

(51) Int. Cl. B01L 3/00

(52) U.S. Cl. CPC B01L 3/502761; B01L 2300/0663

(57) ABSTRACT

Systems and methods for measuring the properties (e.g., masses, weights, densities, etc.) of particles, such as biological entities, in a fluidic channel are generally provided. In some embodiments, the systems and methods comprise a plurality of suspended microchannel resonators (SMRs) configured to operate simultaneously. A particle or a plurality of particles may be dissolved or suspended in a fluid, whereby the fluid is flowed through an inlet (e.g., an inlet channel) that is fluidically connected in parallel and in fluid communication with at least one SMR (e.g. at least one SMR, at least two SMRs, at least four SMRs, at least 8, at least 16 SMRs). Fluid containing a particle or particles may flow into the plurality of SMRs, which may oscillate at a certain frequency (e.g., a resonance frequency). As particles pass through the SMR(s), the mass of particle may cause a change in the resonance frequency, the change in frequency which may be read out via embedded piezoresistors. The SMR may comprise a cantilever, where shifts in the resonance frequency of each cantilever can be tracked independently and whereby frequency-multiplexing allows each cantilever to be continuously driven at the resonance frequency using a single actuation channel and a single detection channel. This may provide a precise, statistically-relevant property determination of the particles within the fluid (e.g., the mass of the particles).

### RELATED APPLICATIONS

This application claims priority under 35 U.S.C. § 119(e) to U.S. Provisional Application No. 62/925,883, filed Oct. 25, 2019, and entitled “RAPID AND HIGH-PRECISION SIZING OF SINGLE PARTICLES USING PARALLEL SUSPENDED MICROCHANNEL RESONATOR ARRAYS AND DECONVOLUTION” and U.S. Provisional Application No. 62/887,504, filed Aug. 15, 2019, and entitled “RAPID AND HIGH-PRECISION SIZING OF SINGLE PARTICLES USING PARALLEL SUSPENDED MICROCHANNEL RESONATOR ARRAYS AND DECONVOLUTION,” which are incorporated herein by reference in their entirety for all purposes.

### GOVERNMENT SPONSORSHIP

This invention was made with Government support under Grant No. R33 CA191143 awarded by the National Institutes of Health. The Government has certain rights in the invention.

### FIELD OF THE INVENTION

The present invention generally relates to the rapid and high-precision sizing of single particles using parallel suspended microchannel resonator arrays and deconvolution.

### BACKGROUND

Measuring the size of micron-scale particles plays a central role in the biological sciences and in a wide range of industrial processes. A variety of size parameters, such as particle diameter, volume, and mass, can be measured using electrical and optical techniques. Suspended microchannel resonators (SMRs) are microfluidic devices that directly measure particle mass by detecting a shift in resonance frequency as cells flow through a resonating micro-cantilever beam. While these devices offer high precision for sizing particles by mass, throughput is fundamentally limited by the small dimensions of the resonator and the limited bandwidth with which changes in resonance frequency can be tracked. Accordingly, improved systems and methods are needed.

### SUMMARY OF THE INVENTION

The present invention generally relates to the rapid and high-precision sizing of single particles using parallel suspended microchannel resonator arrays and deconvolution.

In one aspect, a fluidic system is described, which includes an inlet, a plurality of suspended microchannel resonators comprising a fluidic channel connected fluidically in parallel and in fluidic communication with the inlet, an excitation element for driving one or more of the suspended microchannel resonators, and a sensor associated with the plurality of suspended microchannel resonators. In some embodiments, the plurality of suspended microchannel resonators is configured to be operated essentially simultaneously.

In another aspect, a method for determining a property of a particle is described. The method includes flowing the particle in a device comprising a suspended microchannel resonator, the suspended microchannel resonator comprising a microfluidic channel configured to receive the plurality of particles; driving the suspended microchannel resonators with an excitation element; sensing a resonance frequency of the suspended microchannel resonators as the particle flows in the microfluidic channel; and modifying the resonance frequency of the suspend microchannel resonator to determine the property of the particle.

In a different aspect, a fluidic system is described. The fluidic system may include inlet, a plurality of suspended microchannel resonators comprising a fluidic channel connected fluidically in parallel and in fluidic communication with the inlet, an excitation element for driving one or more of the suspended microchannel resonators, and a sensor associated with the plurality of suspended microchannel resonators. The plurality of suspended microchannel resonators may have a throughput of at least 1,000 particles/min.

Other advantages and novel features of the present invention will become apparent from the following detailed description of various non-limiting embodiments of the invention when considered in conjunction with the accompanying figures. In cases where the present specification and a document Incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of a system for determining a property of a particle, according to one set of embodiments;

FIG. 2 is a schematic illustration of a first and second mode of oscillation and associated resonant peaks for a suspended microchannel having a particle flow through the microchannel, according to one set of embodiments;

FIG. 3A shows one method for increasing the throughput of suspended microchannel resonators by detecting a position-dependent shift in resonance frequency as particles flow through the vacuum- packaged cantilever beam with an embedded microfluidic channel, according to some embodiments;

FIG. 3B shows a model-based deconvolution algorithm to increase the maximum particle speed for which accurate mass measurements can be obtained with the top portion showing limited resonance-tracking bandwidth constrains the maximum throughput of SMRs, since fast resonance frequency shifts cannot be fully resolved by the sensor, resulting in distortion of the measured resonance frequency signal, while the bottom shows a deconvolution- based algorithm that uses knowledge of the expected resonance frequency signal is used to “deblur” the distorted resonance frequency signals and recover particle mass measurements, according to some embodiments;

FIG. 3C is a schematic of parallel SMR array devices, which contain sixteen SMRs connected fluidically in parallel and operated simultaneously to further increase throughput, according to one set of embodiments;

FIGS. 4A-4F illustrate a model-based deconvolution algorithm where measured signals are normalized such that the maximum deviation from the baseline has unit amplitude (FIGS. 4A-4B), normalized signals are compared against a pre-computed library of distorted peak shapes to estimate the particle's transit time (Ttransit) and cantilever entrance time (tenter) (FIGS. 4C-4D), the signal amplitude is fit to minimize deviation between the (scaled) fit peak shape and the measured signal (FIG. 4E), and a pre-computed lookup table of deconvolved peak shapes is used to recover an estimate of the de-blurred signal, for which the peak resonance frequency shift at the antinode is proportional to particle mass (FIG. 4F), according to certain embodiments;

FIG. 5A shows the distorted peak shapes predicted by a linear model of the SMR-PLL resonance-tracking loop, according to some embodiments;

FIG. 5B shows measured peak shapes (gray points) and fits to the linear resonance-tracking model (red line) for 1.1 μm polystyrene beads measured using an SMR with 3×5×120 μm³ channel dimensions, as a function of resonance-tracking bandwidth and particle transit time, according to one set of embodiments;

FIG. 5C shows measured peak amplitudes (amplitude of the first antinode peak; red) and recovered peak amplitudes (top plot) for 1.1 μm polystyrene beads measured across a range of transit times, with LOESS (locally estimated scatterplot smoothing) fits overlaid as solid lines, according to one set of embodiments;

FIG. 5D shows peak measurements simulated by generating theoretical peak shapes with 5 Hz amplitude and varying transit time, convolving with a specified resonance-tracking transfer function to simulate distortion, then corrupted with additive white noise, where, at a particular transit time, measuring the peaks with a fixed, narrow bandwidth (200 Hz) is followed by model-based deconvolution may result in more precise peak amplitude estimates than the alternative approach of increasing the bandwidth to fully resolve the peak signal, whereby the noise spectrum modeled as white, with σ=0.25 Hz at 200 Hz bandwidth, according to some embodiments;

FIG. 5E shows the peak amplitude uncertainty as a function of transit time (i.e., standard deviation of peak height estimates at a particular transit time) for the simulations where, at faster transit times, the deconvolution algorithm (while measuring peaks at a fixed 200 Hz bandwidth) provides more precise peak amplitude estimates than simply increasing the resonance-tracking bandwidth to fully resolve the signal, according to some embodiments;

FIG. 5F illustrates the signal-to-noise ratio decreases monotonically with bandwidth for particles with a particular transit time, i.e., using narrower loop bandwidths increases the signal-to-noise ratio, with diminishing returns at very narrow loop bandwidths, according to one set of embodiments;

FIG. 6A shows resonance frequency signals from ten SMRs operated in parallel on the same chip (out of a maximum of 12), where the plots show a sixty-second sample of the resonance frequency signal from each cantilever, measured in suspension of 7 μm polystyrene beads in phosphate-buffered saline, according to one set of embodiments;

FIG. 6B shows open-loop transfer function amplitude for the parallel SMR array, according to one set of embodiments;

FIG. 6C shows the determination of the maximum throughput where the measured peak amplitude should be attenuated by no more than 1% from the true value, according to some embodiments; and

FIG. 7A shows a comparison between the precision of parallel SMR array as described herein vs. Multisizer 4 Coulter counter, according to one set of embodiments.

FIG. 7B shows shows a comparison between the precision of parallel SMR array as described herein vs. Multisizer 4 Coulter counter, according to one set of embodiments;

FIG. 7C shows the measured coefficient of variation for various particles, according to one set of embodiments;

FIG. 8A is a schematic of the SMR-PLL loop used to continuously drive one or more cantilevers at resonance, according to one set of embodiments;

FIG. 8B shows a phase-domain model of the SMR-PLL feedback loop where the loop filter (transfer function H_{LF}(s) is designed to shape the closed loop resonance-tracking and noise-rejection transfer functions (H_{track}(s), H_{LF}(s)) with the desired dynamics, according to some embodiments;

FIG. 8C shows the transfer function H_{track}(s) and Hₙₒᵢₛₑ(s), according to one set of embodiments;

FIGS. 9A-9B shows a comparison of optimization procedures for optimizing the objective function to fit transit time and entrance time to distorted peaks including (FIG. 9A) the interior-point optimization and (FIG. 9B) genetic algorithm optimization, according to some embodiments;

FIG. 10A shows distorted peak shapes predicted by the linear model of the SMR-PLL resonance-tracking loop, as a function of the dimensionless bandwidth Ttransit×bandwidth where At narrower loop bandwidths, the noise power decreases, while the degree of signal distortion increases, according to one set of embodiments;

FIG. 10B depicts the fraction of total signal energy recovered as a function of the resonance-tracking bandwidth of the SMR-PLL loop (shown here for a first-order resonance-tracking transfer function where the signal is fully resolved (signal energy >99.9%) for dimensionless bandwidths greater than approximately 24, according to one set of embodiments;

FIG. 10C depicts the measured total noise power as a function of resonance-tracking bandwidth, determined from 1-second noise samples where the noise is approximately white (log-log slope approximately +2), according to some embodiments;

FIG. 11A shows measured (red-blue) and predicted (black) impulse response for ten SMR-PLL resonance-tracking loops, each configured with a first-order resonance-tracking transfer function with 100 Hz bandwidth where each trace is the average of 100 impulses induced by instantaneously offsetting the internal PLL phase by ten degrees, according to one set of embodiments;

FIG. 11B depicts measured (red-blue) and predicted (black) resonance-tracking transfer functions for the same ten SMR-PLL resonance-tracking loops, obtained as the Fourier transform of the measured impulse responses, according to some embodiments;

FIG. 11C shows the distribution of particle counts across the twelve sensors of a parallel SMR array measuring suspensions of 7 μm polystyrene particles on different days, where, although the pressure control configuration remains nominally the same from day to day, we observe slight drift in the total fractions of particles passing through each sensor, according to some embodiments;

FIG. 12 illustrates the cantilevers of the parallel SMR arrays were designed with fluidic channels extending only to the antinode when the cantilever is driven in the second mode (˜48% of the cantilever length), resulting in a resonance frequency signal with a single peak when a particle passes through the sensor, which results in reduced position-dependent error (0.2%), since the peak resonance frequency shift is relatively insensitive to whether a particle takes the inner, outer, or center path when turning around at the tip of the cantilever, according to some embodiments;

FIG. 13 shows the probability of two particles occupying the same cantilever simultaneously as a function of sample concentration, according to some embodiments;

FIG. 14A shows the measured mass distributions for a sample of nominal 8 micron polystyrene beads measured on a parallel SMR array, where an average of 874 particles were measured per sensor, with a minimum of 94 in sensor 6, and the mass distribution for each sensor is normalized to mean 1, according to some embodiments; and

FIG. 14B shows the coefficients of variation for each cantilever ranged from 2.1-3.7%, comparable to the overall coefficient of variation of 2.6%, suggesting similar performance between sensors, according to some embodiments.

### DETAILED DESCRIPTION

Systems and methods for measuring the properties (e.g., masses, weights, densities, etc.) of particles, such as biological entities, in a fluidic channel are generally provided. In some embodiments, the systems and methods comprise a plurality of suspended microchannel resonators (SMRs) configured to operate simultaneously. A particle or a plurality of particles may be dissolved or suspended in a fluid, whereby the fluid is flowed through an inlet (e.g., an inlet channel) that is fluidically connected in parallel and in fluid communication with at least one SMR (e.g. at least one SMR, at least two SMRs, at least four SMRs, at least 8, at least 16 SMRs). Fluid containing a particle or particles may flow into the plurality of SMRs, which may oscillate at a certain frequency (e.g., a resonance frequency). As particles pass through the SMR(s), the mass of particle may cause a change in the resonance frequency, the change in frequency which may be read out via embedded piezoresistors. The SMR may comprise a cantilever, where shifts in the resonance frequency of each cantilever can be tracked independently and whereby frequency-multiplexing allows each cantilever to be continuously driven at the resonance frequency using a single actuation channel and a single detection channel. This may provide a precise, statistically-relevant property determination of the particles within the fluid (e.g., the mass of the particles).

The inventors have recognized and appreciated that operating multiple (i.e., at least two) SMRs simultaneously may dramatically increase the throughput, i.e., the number of particles per unit time for which a property may be measured. Thus, in some embodiments, the plurality of suspended microchannel resonators is configured to be operated simultaneously. “Simultaneously” will be understood, in the context of its ordinary meaning in the art, to refer to a plurality of SMRs operating essentially at the same time. That is, in some cases, a small amount of time (<1 s) may pass between the operation of a single SMRs in comparison to other SMRs within the plurality of SMRs, such that the plurality of SMRs operates essentially simultaneously (e.g., each SMR begins operating within less than one second of one another). It will be understood that the phrase “essentially simultaneously” and the term “simultaneously” include resonators that not only start resonating at essentially the same time, but are oscillated within the same time period (e.g., less than one second of one another). For example, a plurality of SMRs in which each SMR is oscillating are generally considered to be operating essentially simultaneously.

In some embodiments, the throughput may also be increased relative to conventional systems by applying a deconvolution method. Such systems and methods may also be useful for measuring the physical properties of a plurality of cells. Thus, in some embodiments, a method is described which comprises flowing a particle in a device, the device comprising a suspended microchannel resonator, the suspended microchannel resonator comprising a microfluidic channel configured to receive the plurality of particles, driving the suspended microchannel resonators with an excitation element, sensing a resonance frequency of the suspended microchannel resonators as the particle flows in the microfluidic channel, and modifying the resonance frequency of the suspend microchannel resonator to determine the property of the particle. In some embodiments, the method may extract mass measurements from measured resonance frequency signals that were created by particles flowing too fast to be fully resolved. The method may correspond to “de-blurring” of the measured resonance frequency signal, which may be “blurred” due to the limited bandwidth of the resonance-tracking loop, analogous to the use of deconvolution in microscopy to de-blur images that were blurred due to diffraction. As one advantage, since the deconvolution operation is performed in post-processing, this approach may be immediately applied to existing SMR systems that are read out using SMR-PLL resonance-tracking loops, without any need for additional hardware modifications. In some embodiments, the systems and methods described herein may have a high throughput of particles (e.g., at least 6,800 particles/min, at least 24,000 particles/min) when compared to conventional systems.

In some embodiments, a deconvolution-based method for extracting mass measurements from resonance frequency data is described, which allows an SMR to accurately measure a particle's mass over 10-fold faster than conventional systems and methods. The methods described herein require no hardware changes and are compatible with implementation on many conventional systems in which the resonances are tracked using phase-locked loops (PLL). In another embodiment, a system is described containing 16 SMRs connected fluidically in parallel and operated simultaneously on the same chip. The systems and methods described may increase sensor throughput (compared to conventional systems and methods) without significantly degrading precision. It should be appreciated that systems and methods described herein may increase throughput by nearly 200-fold compared to previously-described conventional systems. In some cases, increasing the throughput of SMRs will broaden the range of applications for which mass-based particle sizing can be employed.

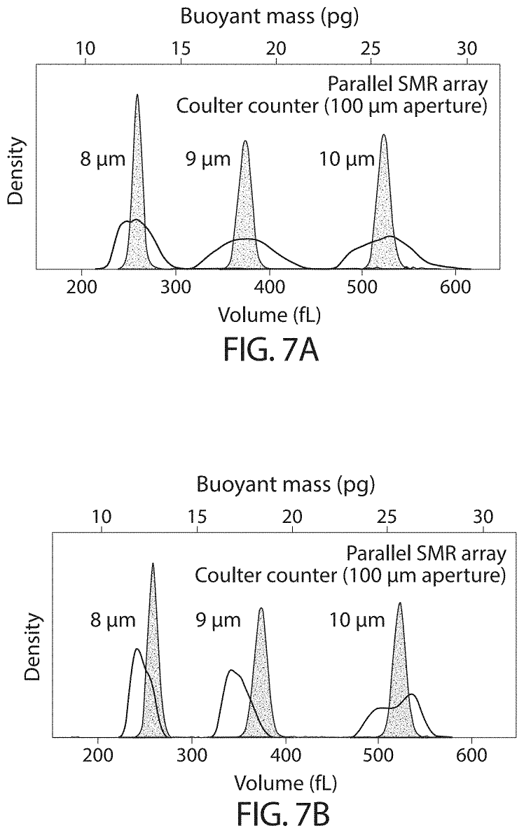

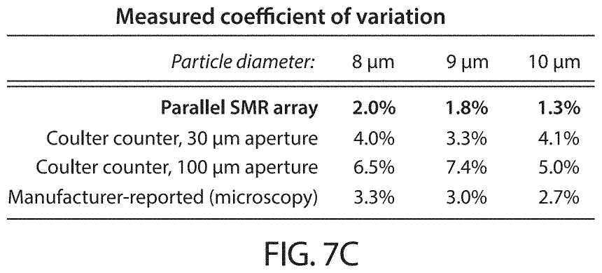

In some embodiments, a method for obtaining accurate and precise mass measurements from particles flowing through the resonator with transit times up to ˜16 times faster than previously possible is described. For certain embodiments, a phase-locked loop (PLL) is used to keep the SMR vibrating at its resonance frequency by forming a resonance-tracking SMR-PLL feedback loop (e.g., FIG. 7). This resonance-tracking loop can be configured with arbitrary response speed, but, without wishing to be bound by theory, due to the fundamental tradeoff between frequency noise and bandwidth, diminishing signal-to-noise ratio sets an upper limit on the achievable resonance-tracking bandwidth. To surpass this throughput limitation, a model-based deconvolution algorithm is described herein, which extracts mass measurements from measured resonance frequency signals that were created by particles flowing too fast to be fully resolved by the resonance-tracking loop (e.g., FIG. 7B) using systems and methods described herein. Without wishing to be bound by theory, this operation corresponds to “de-blurring” of the measured resonance frequency signal, which was “blurred” due to the limited bandwidth of the resonance-tracking loop, analogous to the use of deconvolution in microscopy to de-blur images that were blurred due to diffraction. In some cases, the deconvolution operation is performed in post-processing, so this approach can be immediately applied to existing SMR systems that are read out using SMR-PLL resonance-tracking loops, without any need for additional hardware modifications.

In some embodiments, systems and methods described herein may advantageously provide the ability to distinguish particles of the same size but different densities. In some cases, mass and volume provide equivalent information about a particle's size, such as in suspensions of solid particles of uniform density, where, in these cases, SMRs may still provide an advantage due to their increased precision compared to other size measurements. The increased precision of SMRs relative to other methods increases further for sub-micron-scale particles: SMRs have been successfully scaled down to measuring particles with buoyant masses as small as ˜10 ag (10 nm gold nanoparticles), while miniaturized resistive pulse sensing instruments have been limited to particles 50 nm or larger. The systems and methods developed here may be equally useful for increasing throughput for SMRs of all size scales.

As mentioned above, systems and methods may be used to determine a property of a particle. In some embodiments, the particle is a biological entity. Non-limiting examples of biological entities include virions, bacteria, protein complexes, exosomes, cells (e.g. cancer cells), or fungi (e.g., yeast). In some embodiments, the biological entity is obtained from a subject. A “subject” refers to any animal such as a mammal (e.g., a human). Non-limiting examples of subjects include a human, a non-human primate, a cow, a horse, a pig, a sheep, a goat, a dog, a cat or a rodent such as a mouse, a rat, a hamster, a bird, a fish, or a guinea pig. In an exemplary embodiment, the biological entity is a human cell. In some embodiments, the systems and methods described herein are useful for measuring the acoustic scattering of biological entities obtained from a subject for, for example, determining one or more physical properties of the biological entity, sorting, and/or diagnostic purposes. In some embodiments, the particle is non-biological comprising a material such as a metal, polymer, ceramic, and/or glass. In certain embodiments, the particle is a polymer. Non-limiting examples of polymer particles that may be measured include polystyrene.

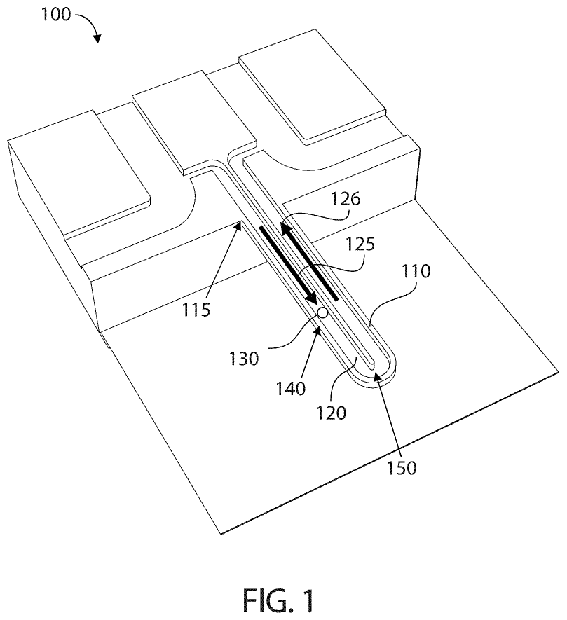

For example, as illustrated in FIG. 1, system 100 comprises a suspended cantilever 110 (e.g., comprising fixed end 115) comprising a suspended fluidic channel 120. In some embodiments, suspended cantilever 110 may be oscillated (e.g., by transversely displacing fixed end 115) at a (mechanical) resonant frequency of suspended cantilever 110. In some cases, a particle 130 (e.g., a biological entity) may be flowed into fluidic channel 120. In some embodiments, an acoustic scattering signal may be measured as particle 130 flows in (micro)fluidic channel 120 (e.g., in the direction of arrow 125). In certain embodiments, the change in resonant frequency of suspended cantilever 110 may be determined as particle 130 flows along fluidic channel 120.

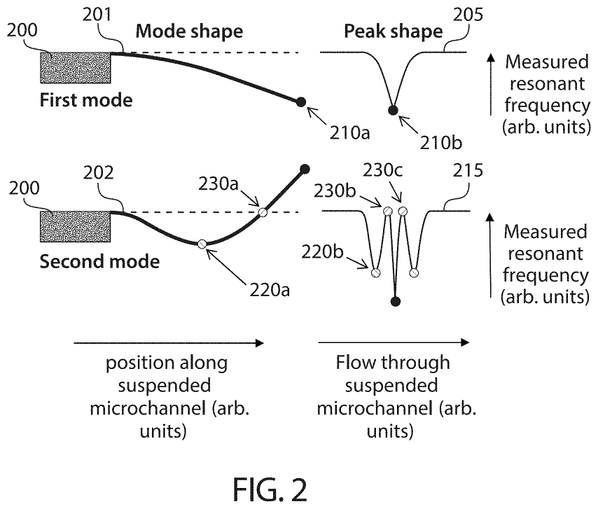

In some embodiments, a node deviation of a single particle may be determined. The term node deviation, as used herein, refers to the difference between the resonant frequency of the suspended microchannel when a particle is present at a node of the suspended microchannel and the resonant frequency of the suspended microchannel when the particle is not present in the suspended microchannel. The term node, as used herein, is given its ordinary meaning in the art and generally refers to a position along the suspended microchannel in which no transverse or out-of-plane movement of the suspended microchannel is observed when the suspended microchannel is oscillated at a mechanical (bending) mode of the cantilever (or channel). For example, as illustrated schematically in FIG. 2, suspended microchannel 200 may be oscillated, for example, such that the vibrational profile of the suspended microchannel 200 undergoes a first bending mode 201 (e.g., oscillated at a mechanical resonant mode with a first lowest frequency) such that a free end 210a of suspended microchannel 200 may oscillate. In certain embodiments, a particle (not shown) may be flowed along suspended microchannel 200 and the resonant frequency of the suspended microchannel may be measured as the particle travels along the suspended microchannel. In some cases, when the particle is traveling along the suspended microchannel 200, the resonant frequency of the first mode may changes creating a peak shape 205. In some cases when the particle is located at or passing through the free end 210a (under a first mode of oscillation), the suspended microchannel may have a resonant frequency 210b.

In some cases, suspended microchannel 200 may be oscillated at a second bending mode (e.g., oscillated at a mechanical out-of-plane resonant mode with a second lowest frequency) such that suspended microchannel 200 undergoes a second bending mode 202. In some such embodiments, oscillated suspended microchannel 200 may have a node position 230a, at which no transverse movement of the suspended microchannel occurs. In some cases, when a particle is traveling along the suspended microchannel 200, the resonant frequency of the second mode changes, creating a peak shape 215. In some embodiments as the particle travels through the suspended microchannel 200, it passes through the node 230a at least once (e.g., twice as particle 130 flows along direction 125 to tip 150 and as it flows along direction 126 away from tip 150 in FIG. 1). In some embodiments, a particle at position 230a may cause the suspended microchannel to have a resonant frequency 230b (and 230c, in some cases, if the particle travels back along the suspended microchannel).

In some embodiments, a channel (e.g., a fluidic channel, a microfluidic channel) can extend to the anti-node location of an SMR (e.g., has a length equal to the anti-node location of the SMR). For example, in some embodiments, an anti-node location refers to a location along an SMR where the frequency shift of the suspended microchannel is generally insensitive to the lateral position of the particle within the microchannel resonator when the suspended microchannel is oscillated at a mechanical (bending) mode of the cantilever (or channel). In some embodiments, the fluidic system or method can comprise a fluidic channel or a microfluidic channel that comprises a length extending to (e.g., equal to) an anti-node location of the suspended microchannel resonator. In some such embodiments, the signal that is achieved is a single peak that uses the same bandwidth as a double peak profile (e.g., without a length equal to the anti-node of the SMR). Advantageously, in some embodiments, the concentration of particles in the single peak case can be at least twice much as the double peak case, which, in some cases, can at least double the particle throughput as compared to the double peak case.

In some embodiments, a particle or plurality of particles may be introduced to the system by at least one inlet. The inlet may be a fluidic channel of any suitable size. In some embodiment, a plurality of suspended microchannel resonators comprises a fluidic channel connected fluidically in parallel and in fluidic communication with the inlet. Thus according to certain embodiment, the inlet may be in fluidic communication with at least one SMR. In some cases, the inlet is fluidic communication with more than one SMR (e.g., at least 2 SMRs, at least 4 SMRs, at least 16 SMRs). In some embodiments, the inlet is connected fluidically in parallel and in fluidic communication with a plurality of SMRs, such that a high throughput of particles (e.g. at least 3,000 particles/min) may flow through the inlet, to a plurality of SMRs in parallel in order to determine a property of the particles with a high throughput.

Without wishing to be bound by theory, in some cases, the throughput of SMRs may be fundamentally limited by the temporal resolution with which changes in resonance frequency and can be tracked. To increase volumetric throughput, particles can transit the cantilever more quickly, and so wider resonance-tracking bandwidths are useful to fully resolve the position-dependent shift in resonance frequency caused by the added mass of the moving particle. Specifically, for a particle flowing at constant speed through a cantilever driven in the second bending mode, the resonance-tracking loop may, in some cases, have bandwidth (in Hz) at least 24 times greater than the characteristic frequency 1/Tₜᵣₐₙₛᵢₜ in order for the transient resonance frequency shift to be fully resolved with >99.9% energy recovery.

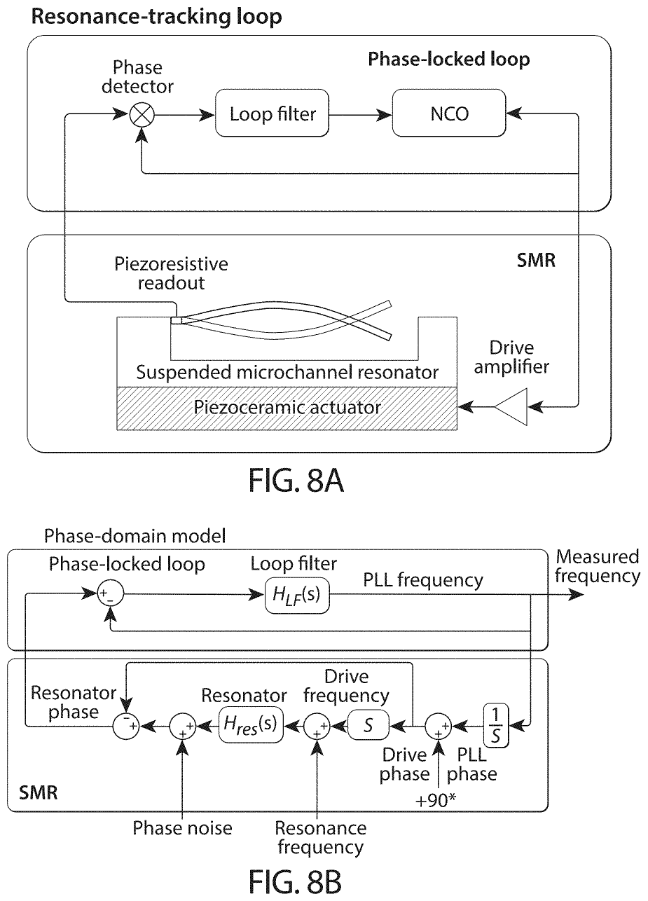

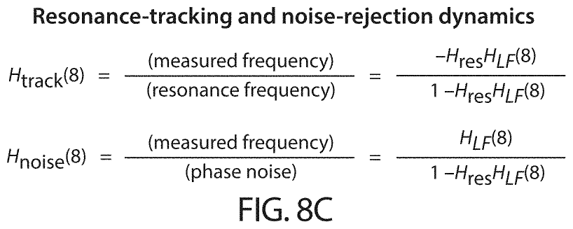

When this bandwidth is not met, the measured resonance frequency signal may become distorted by the limited bandwidth of the resonance-tracking loop. The degree of distortion depends on the specific resonance-tracking transfer function, mostly by the relative values of the loop bandwidth and transit time. Configuring the resonance-tracking loop with a wider bandwidth may enable the measurement of faster particles without distortion of the resonance frequency signal, but may be at the expense of widening the noise bandwidth (e.g., FIG. 8).

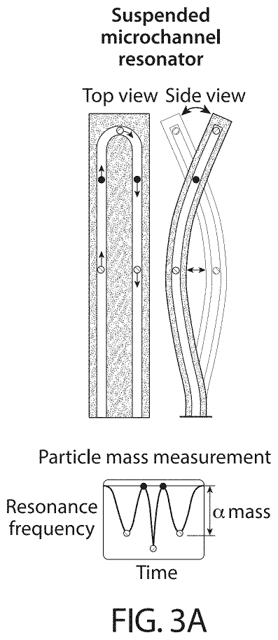

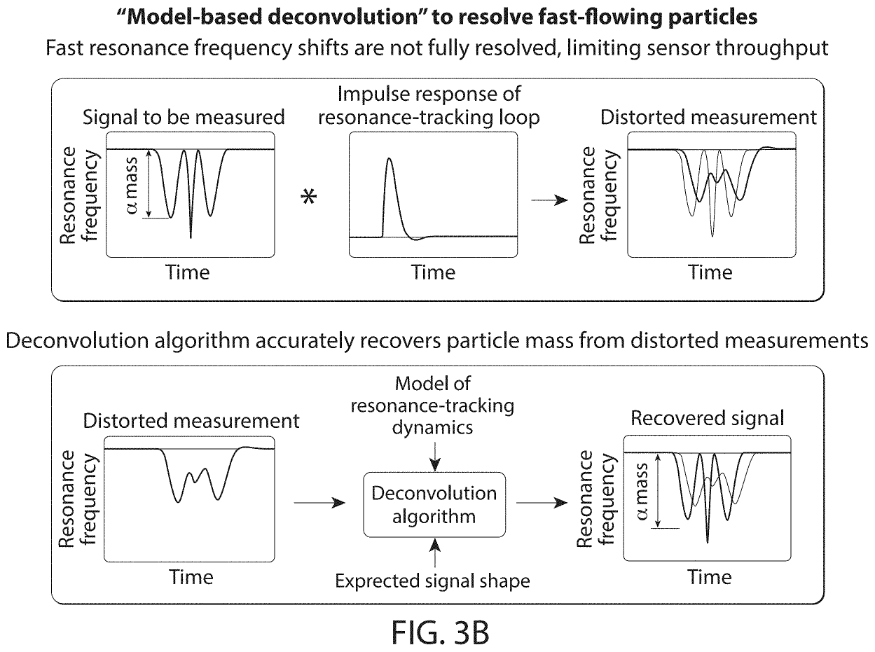

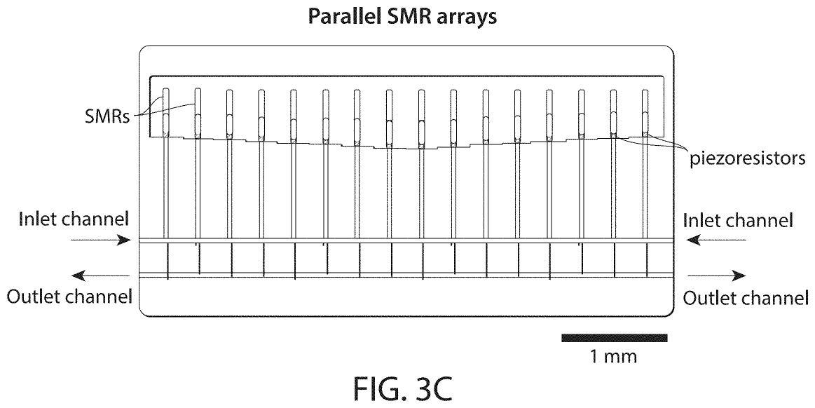

In some embodiments, at least one (e.g., a plurality) of suspended microchannel resonators comprises a fluidic channel connected fluidically in parallel and in fluidic communication with the inlet. As used herein, “fluidically in parallel” has its ordinary meaning in the art to refer to components connected along multiple paths so that the flow of a fluidic may be split up. In some embodiments, a microfluidic device containing sixteen SMRs connected fluidically in parallel and operated simultaneously (e.g., FIG. 3C) is described. In some embodiments, shifts in the resonance frequency of each cantilever can be tracked independently, and frequency-multiplexing allows each cantilever to be continuously driven at resonance using a single actuation channel and single detection channel. In some cases, the precision of the parallel SMR arrays may be evaluated by measuring suspensions of monodisperse polystyrene beads, obtaining coefficients of variation up to ˜4 times lower than a commercial Coulter counter configured for a similar size range.

In some embodiments, a microfluidic device containing sixteen SMRs connected fluidically in parallel and operated simultaneously (e.g., FIG. 3C) is described. In some embodiments, shifts in the resonance frequency of each cantilever can be tracked independently, and frequency-multiplexing allows each cantilever to be continuously driven at resonance using a single actuation channel and single detection channel. In some cases, the precision of the parallel SMR arrays may be evaluated by measuring suspensions of monodisperse polystyrene beads, obtaining coefficients of variation up to ˜4 times lower than a commercial Coulter counter configured for a similar size range.

Systems and methods may comprise one or more suspended microchannel resonators. In embodiments in which the system comprises one or more suspended microchannel resonators (e.g., comprising a suspended microchannel), the suspended microchannel resonator may have one or more characteristics described in commonly-owned U.S. Pat. No. 7,387,889, entitled “Measurement of concentrations and binding energetics”, issued Jun. 17, 2008; commonly-owned U.S. Pat. No. 7,838,284, entitled “Measurement of concentrations and binding energetics”, issued Nov. 23, 2010; commonly-owned U.S. Pat. No. 9,134,294, entitled “Method And Apparatus For High Throughput Diagnosis Of Diseased Cells With Microchannel Devices”, issued Sep. 15, 2015; commonly-owned U.S. Pat. No. 9,134,295, entitled “Serial Arrays of Suspended Microchannel Resonators”, issued Sep. 15, 2015; commonly-owned U.S. Pat. No. 8.087,284, entitled “Method And Apparatus For Measuring Particle Characteristics Through Mass Detection”, issued Jan. 3, 2012; commonly-owned U.S. Pat. No. 8,722,419, entitled “Flow cytometry Methods And Immunodiagnostics With Mass Sensitive Readout”, issued May 13, 2014; commonly-owned U.S. patent application Ser. No. 14/924,531, entitled “Simultaneous oscillation and frequency tracking of multiple resonances via digitally implemented phase-locked loop array”, filed Oct. 27, 2015; each of which is incorporated herein by reference in its entirety for all purposes.

In some embodiments, the system comprises an excitation element for driving one or more suspended microchannel resonators. The system may comprise one or more components for oscillating the suspended microchannel(s) and/or measuring the oscillation (and/or resonant frequency) of the suspended microchannel(s). For example, in some embodiments, the system comprises an actuator configured to vibrate (e.g., oscillate) the suspended microchannel (e.g., at a particular frequency and/or bending mode).

In certain embodiments, the system may comprise a controller and/or microprocessor. In certain embodiments, the controller is configured (e.g., programmed) to receive and transmit data commands to/from one or more components of the system (e.g., the excitation element, the sensor and/or detector, SMRs, etc.). In some embodiments, the data includes one or more signals from one or more detector. In some embodiments the controller and/or microprocessor is configured to determine the resonant frequency of the suspended microchannel. In some embodiments, the controller may be configured to adjust various parameters based on external metrics. For example, in certain embodiments, the controller is configured to adjust the oscillation frequency of the suspended microchannel in response to a signal from a user and/or a detector in electrical communication with the controller. In some embodiments, the controller adjusts the oscillation frequency in response to a signal from the detector due to a particle in the channel (e.g., such that the suspended microchannel oscillates at a resonant bending mode with at least one node location at its bending profile).

In some embodiments, the controller may include one or more proportional, integral (PI), and/or derivative (PID) feedforward and/or feedback loops to adjust the oscillation frequency of the suspended microchannel. The controller may be implemented by any suitable type of analog and/or digital circuitry. In one embodiment the controller may be implemented in a field programmable gate array (FPGA). For example, the controller may be implemented using hardware or a combination of hardware and software. When implemented using software, suitable software code can be executed on any suitable processor (e.g., a microprocessor, FPGA) or collection of processors. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, or other tangible, non-transitory computer-readable storage medium) encoded with a computer program (i.e., a plurality of executable instructions) that, when executed on one or more processors, performs the above discussed functions of one or more embodiments. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

In some embodiments, the microchannel of the system (e.g., SMR) may have any suitable cross-sectional shape (e.g., circular, oval, triangular, irregular, trapezoidal, square or rectangular, serpentine, u-shaped, or the like). A fluidic channel may also have an aspect ratio (length to average cross sectional dimension) of at least 2:1, more typically at least 3:1, 5:1, or 10:1 or more. A fluid within the fluidic channel may partially or completely fill the fluidic channel.

In some embodiments, the microchannel (e.g., SMR) may have a particular configuration. In certain embodiments, at least a portion of the microchannel may be substantially linear in the direction of fluid flow. In some embodiments, at least a portion of the microchannel may be curved, bent, serpentine, staggered, zig-zag, spiral, or combinations thereof. Advantageously, the use of a non-linear fluidic channels may permit the incorporation of two or more suspended microchannel resonators into the system (e.g., such that a plurality of particles may be measured in parallel, such that a change in a property of a single particle may be determined e.g., in series or in parallel).

The system or portions thereof (e.g., a suspended microchannel) described herein can be fabricated of any suitable material. Non-limiting examples of materials include polymers (e.g., polypropylene, polyethylene, polystyrene, poly(acrylonitrile, butadiene, styrene), poly(styrene-co-acrylate), poly(methyl methacrylate), polycarbonate, polyester, poly(dimethylsiloxane), PVC, PTFE, PET, or blends of two or more such polymers), adhesives, and/or metals including nickel, copper, stainless steel, bulk metallic glass, or other metals or alloys, or ceramics including glass, quartz, silica, alumina, zirconia, tungsten carbide, silicon carbide, or non-metallic materials such as graphite, silicon, or others.

In some embodiments, a particle or a plurality of particles (e.g., a plurality of biological entities) are provided (e.g., suspended) in a fluid. As used herein, a “fluid” is given its ordinary meaning, i.e., a liquid or a gas. A fluid cannot maintain a defined shape and will flow during an observable time frame to fill the container in which it is put. Thus, the fluid may have any suitable viscosity that permits flow. In a particular set of embodiments, the fluid is a liquid. In some embodiments, the fluid comprises water, blood, plasma, a reagent, a solvent, a buffer, a cell-growth medium, or combinations thereof. In certain embodiments, the particles are relatively soluble in the fluid.

The plurality of particles may be, in some cases, suspended in a fluid. For example, the particles may be, in some cases, suspended in liquid and/or a solvent. In some embodiments, the concentration of particles (e.g., concentration in a fluid, concentration in a solution) can be selected to increase (e.g., maximize) the throughput of particles within the SMR while reducing (or eliminating) a double occupancy event (e.g., two particles present at the same time). Without wishing to be bound by theory, the maximum concentration of the particle suspension may be, in some cases, limited by the restriction that only one particle can occupy each cantilever at a time such that double occupancy (or higher order occupancy) is prevented. In some embodiments, the probability of a double occupancy (or higher occupancy) is kept relatively low (e.g., less than or equal to 10%, less than or equal to 1%, less than or equal to 0.1%) such that the majority (e.g., greater than or equal to 90%, greater than or equal to 95%, greater than or equal to 99%, greater than or equal to 99.9%, greater than or equal to 99.99%) only one particle can occupy each cantilever of an SMR. The probability of double-occupancy events—instances where two particles occupy a cantilever at the same time—may be, in some cases, modeled as a function of sample concentration, modeling particle loading as a Poisson process, as described further below. In some cases, limiting the likelihood of double-occupancy events to less than or equal to 10% may correspond to an average sample concentration of less than one particle per about 10 cantilever volumes. For the parallel SMR arrays, in some cases and without wishing to be bound by theory, this correspondence may limit the maximum particle concentration to approximately 850 particles/μL. In some embodiments, the parallel SMR array can achieve a throughput of ˜6800 particles/minute (e.g., through 12 sensors) which represents an advantageous at least 55-fold improvement compared to a single SMR operating with the same resonance-tracking bandwidth.

In some embodiments, the fluid or system is maintained under physiological conditions (e.g., for measuring cell growth). For example, in some embodiments, the fluid and/or the system is maintained at 37° C. and, optionally, pressurized with a 5% carbon dioxide gas mixture (e.g., to maintain pH stability of the growth media).

Fluids can be introduced (e.g., transport, flowed, displaced) into the system (or a fluidic channel therein (e.g., the microchannel)) using any suitable component, for example, a pump, syringe, pressurized vessel, or any other source of pressure. Alternatively, fluids can be pulled into the fluidic channel by application of vacuum or reduced pressure on a downstream side of the channel or device. Vacuum may be provided by any source capable of providing a lower pressure condition than exists upstream of the channel or device. Such sources may include vacuum pumps, venturis, syringes and evacuated containers. It should be understood, however, that in certain embodiments, methods described herein can be performed with a changing pressure drop across a fluidic channel by using capillary flow, the use of valves, or other external controls that vary pressure and/or flow rate.

In certain embodiments, the suspended microchannel may comprise one or more fluidic channels having a particular average cross-sectional dimension. The “cross-sectional dimension” (e.g., a width, a height, a radius) of the channel is measured perpendicular to the direction of fluid flow. In some embodiments, the average cross-sectional dimension of one or more fluidic channels is less than or equal to 2 mm, less than or equal to 1 mm, less than or equal to 800 microns, less than or equal to 600 microns, less than or equal to 500 microns, less than or equal to 400 microns, less than or equal to 300 microns, less than or equal to 200 microns, less than or equal to 100 microns, less than or equal to 50 microns, less than or equal to 25 microns, less than or equal to 20 microns, less than or equal to 15 microns, or less than or equal to 10 microns, or less than or equal to 5 microns. In certain embodiments, the average cross-sectional dimension of the fluidic channel(s) is greater than or equal to 1 microns, greater than or equal to 5 microns, greater than or equal to 10 microns, greater than or equal to 15 microns, greater than or equal to 20 microns, greater than or equal to 25 microns, greater than or equal to 50 microns, greater than or equal to 100 microns, greater than or equal to 200 microns, greater than or equal to 300 microns, greater than or equal to 400 microns, greater than or equal to 500 microns, greater than or equal to 600 microns, greater than or equal to 800 microns, or greater than or equal to 1 mm. Combinations of the above-referenced ranges are also possible (e.g., greater than or equal to 1 micron and less than or equal to 2 mm, greater than or equal to 50 microns and less than or equal to 2 mm). Other ranges are also possible. In some embodiments, one or more channels may be a microfluidic channel. “Microfluidic channels” generally refer to channels having an average cross-sectional dimension of less than 1 mm.

In some embodiments, a single particle may flow in the microchannel at a particular average velocity (e.g., along a longitudinal axis of the microchannel). In certain embodiments, the average velocity of the particle(s) along the longitudinal axis of the microchannel is greater than or equal to 0.05 mm/second, greater than or equal to 0.1 mm/second, greater than or equal to 0.25 mm/second, greater than or equal to 0.5 mm/second, greater than or equal to 0.75 mm/second, greater than or equal to 1 mm/second, greater than or equal to 2 mm/second, greater than or equal to 3 mm/second, greater than or equal to 4 mm/second, greater than or equal to 5 mm/second, greater than or equal to 6 mm/second, greater than or equal to 7 mm/second, greater than or equal to 8 mm/second, or greater than or equal to 9 mm/second. In some embodiments, the average velocity of the particles along the longitudinal axis of the microchannel is less than or equal to 10 mm/second, less than or equal to 9 mm/second, less than or equal to 8 mm/second, less than or equal to 7 mm/second, less than or equal to 6 mm/second, less than or equal to 5 mm/second, less than or equal to 4 mm/second, less than or equal to 3 mm/second, less than or equal to 2 mm/second, less than or equal to 1 mm/second, less than or equal to 0.75 mm/second, less than or equal to 0.5 mm/second, or less than or equal to 0.25 mm/second. Combinations of the above-referenced ranges are also possible (e.g., greater than or equal to 0.05 mm/second and less than or equal to 10 mm/second). Other ranges are also possible.

There are several single-particle approaches that are routinely used for sizing particle suspensions in the 5-20 μm size range. Resistive-pulse sensing instruments (such as the Coulter counter) achieve volumetric precision on the order of 1-10% in this size range, with throughput of thousands of cells per minute due to the continuous flow-through nature of the measurement. Transmitted- and reflected-light microscopy can measure particle diameter and infer particle volume with precision similar to the Coulter counter, provided that the particles are approximately spherical; commercial “micro-flow imaging” systems perform these measurements on flowing particles at rates as high as 100 μL/min. To size non-spherical particles and cells, other imaging modalities such as quantitative phase microscopy have been used.

In contrast with these techniques, which size particles by electrical or optical methods, in some embodiments, suspended microchannel resonators directly measure particle buoyant mass by detecting a shift in resonance frequency as particles flow through a vacuum-packaged cantilever beam containing a U-shaped microfluidic channel (e.g., FIG. 3A). According to some embodiments, in the 5-20 μm size range, SMRs can achieve mass precision on the order of 0.1-1%. However, to date, the throughput of SMRs has been limited to tens of particles per minute, restricting their use to applications requiring highly precise measurements of relatively small numbers of particles.

According to some embodiments, system and methods described may increase the throughput of particles passing through an SMR. As used herein “throughput” describes the number of particles (e.g., polymer beads, cells, etc.) or frequency of particles (per unit time) through one or more SMRs. In certain embodiments, the particle(s) may be dissolved or suspended in a fluid, and the throughput may be alternatively measured as the number of particle per volume of fluid. Methods of measuring the throughput of particles is described below in at least Example 3. In some cases, systems and methods described herein may increase the throughput of particles relative to conventional systems. In some embodiments, the throughput of particles is at least 1,000 particles per minute, at least 3,000 particles per minute, at least 6,000 particles per minute, at least 9,000 particles per minute, at least 12,000 particles per minute, at least 15,000 particles per minute, at least 18,000 particles per minute, at least 21,000 particles per minute, at least 24,000 particles per minute, at least 36,000 particles per minute, at least 48,000 particles per minute, at least 60,000 particles per minute, at least 72,000 particles per minute, at least 84,000 particles per minute, or at least 100,000 particles per minute. In some embodiments, the throughput of particles is no greater than 100,000 particles per minute, no greater than 84,000 particles per minute, no greater than 72,000 particles per minute, no greater than 60,000 particles per minute, no greater than 48,000 particles per minute, no greater than 36,000 particles per minute, no greater than 24,000 particles per minute, no greater than 21,000 particles per minute, no greater than 18,000 particles per minute, no greater than 15,000 particles per minute, no greater than 12,000 particles per minute, no greater than 9,000 particles per minute, no greater than 6,000 particles per minute, no greater than 3,000 particles per minute, or no greater than 1,000 particles per minute. Combinations of the above-referenced ranges are also possible (e.g., at least 1,000 particles per minute and no greater than 24,000 particles per minute, e.g., no greater than 21,000 particles per minute and at least 3,000 particles per minute). The throughput of particles may be measured by systems and methods described herein.

The following examples are intended to illustrate certain embodiments of the present invention, but do not exemplify the full scope of the invention.

### EXAMPLE 1

### Model-Based Deconvolution

The following example describes the deconvolution of distorted resonance frequencies for increased throughput for measuring properties of a plurality of particles (e.g., mass).

In order to increase the maximum particle speed that can be measured at a particular resonance or tracking bandwidth (and therefore with constant measurement noise), it was explored whether one could computationally analyze distorted resonance frequency signals to estimate the true, fully-resolved (i.e., deconvoluted) resonance frequency signal, which encodes the particle's mass. Since the distorted resonance frequency measurement is mathematically the convolution of the true resonance frequency signal with the closed-loop impulse response of the resonance-tracking loop, one could potentially deconvolve the known resonance-tracking impulse response from the distorted measurement to arrive at an estimate of the original resonance frequency shift signal. There exist various computational approaches for performing this deconvolution operation, including classical Tikhonov-Wiener approaches and more modern statistical methods. However, this application differs from the classical deconvolution problem, since more information is available; the shape of the true resonance frequency signal is known, while only its amplitude and duration are unknown.

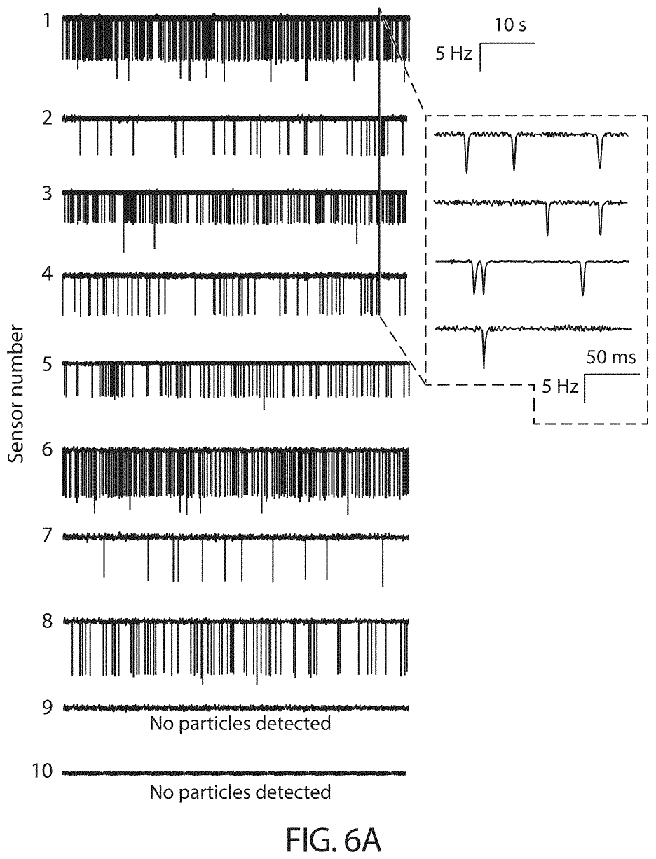

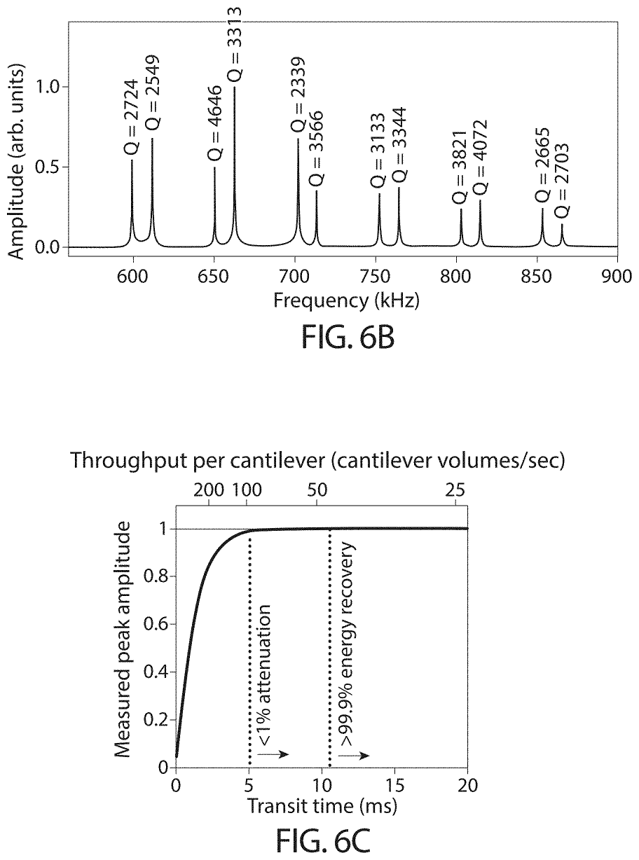

In some embodiments, a deconvolution-based signal recovery algorithm is described (e.g., FIG. 6) that uses knowledge of the expected shape of the true resonance frequency signal to estimate a particle's mass and transit time by comparing the measured peak shape against a pre-computed library of distorted peak shapes. The library of distorted peak shapes, in some cases, is generated by convolving theoretical (non-distorted) peak shapes of varying transit time with the impulse response of the measured resonance-tracking transfer function, to predict the distorted peak shapes that would be observed for particles with a particular transit time. In some cases, measured distorted peak shapes are compared against this library, and an optimization procedure is used to fit three parameters to the measurement: the time at which the particle entered the cantilever, its transit time, and the amplitude of the distorted peak. Modeling the distorted measurement as the convolution of the theoretical peak shape with the resonance-tracking impulse response, these three parameters (the particle's entrance time, transit time, and signal amplitude) are, in some embodiments, sufficient to fully recover an estimate of the true resonance frequency signal, which encodes the particle's mass.

### Details of Deconvolution Algorithm

Without wishing to be bound by theory, the “model-based deconvolution” algorithm works as follows. Generating a library of blurred peak shapes first requires knowledge of the theoretical peak shape. The position-dependent resonance frequency shift that occurs when a particle flows through the resonating cantilever, normalized to unit maximum amplitude, is given by

$${f}_{SMR} ( t , {T}_{transit} ) = \frac{- {u}_{n}^{2} ( z ( t ) )}{{( {u}_{n}^{2} )}_{ma x }} \qquad ( 1 )$$

where uₙ²(z) is the cantilever deflection at position z (normalized such that z=0 at the cantilever base and z=1 at the cantilever tip) when driven in mode n (here, n=2), and uₙ²_{antinode} is the maximum squared deflection of the cantilever. For the particle trajectory z(t), the particle was approximated as moving at a constant speed to the end of the fluidic channel (96.5% of the total cantilever length for our devices) then instantly turning and returning to the base of the cantilever at the same speed.

The PLL frequency signal, i.e., the time-varying estimate of the resonance frequency generated by a phase-locked loop in feedback with an SMR, is modeled as the convolution of this theoretical resonance frequency signal with the (user-specified) resonance-tracking impulse response given by h_{SMR}:

f_{PLL}(t, Tₜᵣₐₙₛᵢₜ, h_{track})=f_{SMR}(t, Tₜᵣₐₙₛᵢₜ)*h_{SMR}(t) (2)

i.e., the theoretical resonance frequency signal is distorted, or “blurred”, by the resonance-tracking impulse response.

Any distorted resonance frequency signal (and its corresponding de-blurred resonance frequency signal) can be uniquely specified by three parameters: the time at which the particle enters the cantilever (tₑₙₜₑᵣ), the particle's transit time through the cantilever (Tₜᵣₐₙₛᵢₜ), and the signal amplitude (A_{PLL} and Aᵣₑₛ for the distorted and de-blurred signals respectively). Therefore, assuming the particle travels at a constant speed and that the SMR-PLL impulse response is known accurately, determining these three parameters from the distorted signal is sufficient to recover an estimate of the de-blurred resonance frequency signal.

The followinging three parameters (tₑₙₜₑᵣ, Tₜᵣₐₙₛᵢₜ, and A_{PLL}) from distorted peak measurements were determined as follows.

First, a library of distorted peak shapes (normalized to unit maximum resonance frequency shift) as a function of particle transit time using the measured resonance-tracking transfer function was pre-computed. The library contains pre-computed peak shapes for the full range of transit times expected to be observed in the data—in our case, 1 to 100 ms, in steps of 0.1 ms.

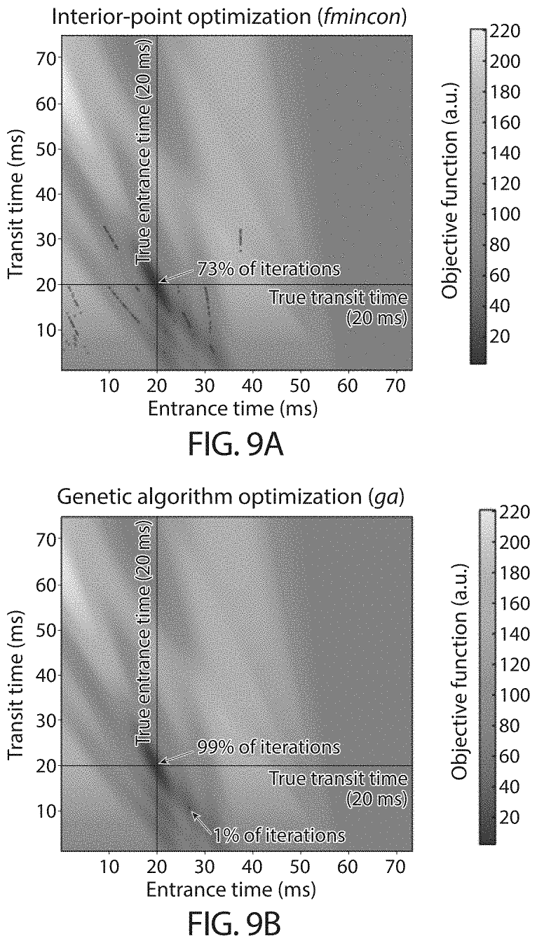

Second, an entrance time (tₑₙₜₑᵣ) and transit time (T_{Transit}) was fitted to the measured peak shape by normalizing it to unit maximum amplitude and searching the library of distorted peak shapes for the best fit, minimizing the following objective function:

$${χ}^{2} ( {t}_{enter} , {T}_{transit} ) = {\sum }_{i} {[ \frac{{f}_{measure} ( {t}_{i} )}{{\vert {f}_{measure} \vert}_{ma x}} - \frac{{f}_{library} ( {t}_{i} - {t}_{enter} , {T}_{transit} , {h}_{track} )}{{\vert {f}_{libray} \vert}_{ma x}} ]}^{2} \qquad ( 3 )$$

where the summation index runs over the length of the measured signal. Since this objective function contains many saddle points and local minima, best performance was achieved using a genetic algorithm for the optimization (the MATLAB implementation ga). The performance of the genetic algorithm was evaluated using simulations, and found that it correctly estimated transit time (within +/−1 ms of the true value for a 20 ms peak) in approximately 99% of cases (FIG. 9). Using the approach, the transit time fit to a particular peak is limited to the finite set of transit times for which peak shapes have been pre-computed and stored in the library of peak shapes; however, one can fit the transit time with arbitrary precision by including more transit times in the peak shape library. Typically, 0.1 ms resolution were found to be more than sufficient.

Third, after fitting an entrance time and transit time to the normalized measured peak shape, the distorted signal amplitude (A_{PLL}) was fit to the non-normalized measured peak shape by minimizing the following objective function:

$${χ}^{2} ( {A}_{PLL} ) = {\sum }_{i} {[ {f}_{measured} ( {t}_{i} ) - {A}_{PLL} \frac{{f}_{library} ( {t}_{i} - {t}_{enter} , {T}_{transit} , {h}_{track} )}{{\vert {f}_{libray} \vert}_{ma x}} ]}^{2} \qquad ( 4 )$$

using MATLAB nonlinear programming solver fmincon.

Finally, after fitting an entrance time, transit time, and signal amplitude to the distorted peak, the pre-computed library of distorted peaks was used to look up the de-blurred peak shape corresponding to the observed distorted peak shape, yielding a recovered estimate of the true resonance frequency signal, for which the resonance frequency shift at the antinode is proportional to the particle's mass. Specifically, this procedure was implemented in two steps. First, the peak library was used to look up the maximum amplitude of the de-blurred signal (Aᵣₑₛ) as a function of transit time and the maximum amplitude of the amplitude of the distorted signal (A_{PLL}). However, for SMRs operated in the second vibrational mode, the resonance frequency shift at the antinode (A_{antinode}) is proportional to the particle's mass. Fortunately, A_{antinode} is related to the maximum amplitude Aᵣₑₛ by a constant multiplicative factor, which depends only on the length of the fluidic channel relative to the cantilever (A_{antinode}=0.809Aᵣₑₛ for some exemplary devices, for which the fluidic channel extends 96.5% of the length of the cantilever). Scaling Aᵣₑₛ by this factor results in an estimate of the resonance frequency shift when the particle is at the antinode, which is directly proportional to particle mass, regardless of the length of the fluidic channel relative to the cantilever.

Applying this deconvolution algorithm is computationally more complex than the simple case where the resonance frequency signal is fully resolved and particle mass can be estimated simply by measuring the peak amplitude. Typically, the rate-limiting step for deconvolution is applying the genetic algorithm to fit the distorted peak's transit time and entrance time. However, in some cases, the implementation of the algorithm running on a mid-range desktop computer can complete this operation in 50-100 ms per peak, which has been sufficient for current applications. In the future, optimizing the implementation of the algorithm may be beneficial if computation becomes a rate-limiting step for data collection.

### Linear Resonance-Tracking Model

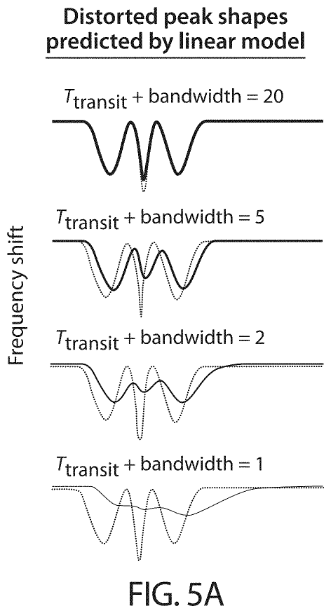

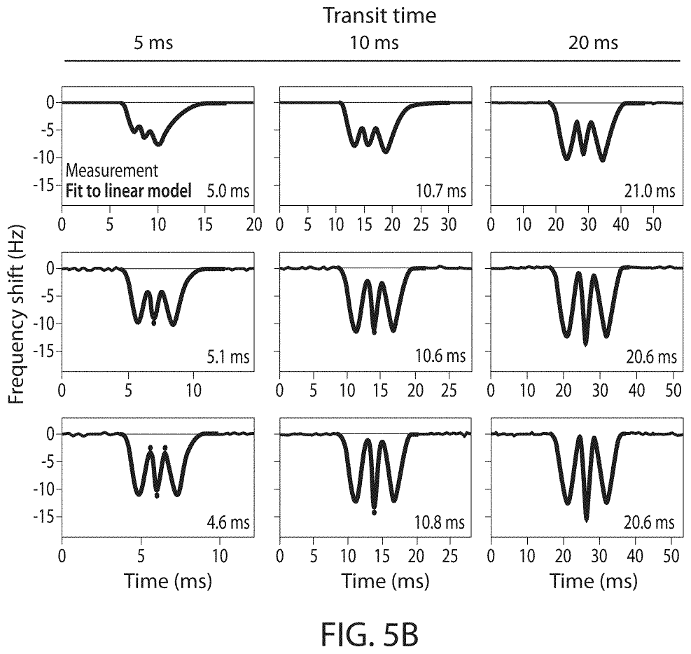

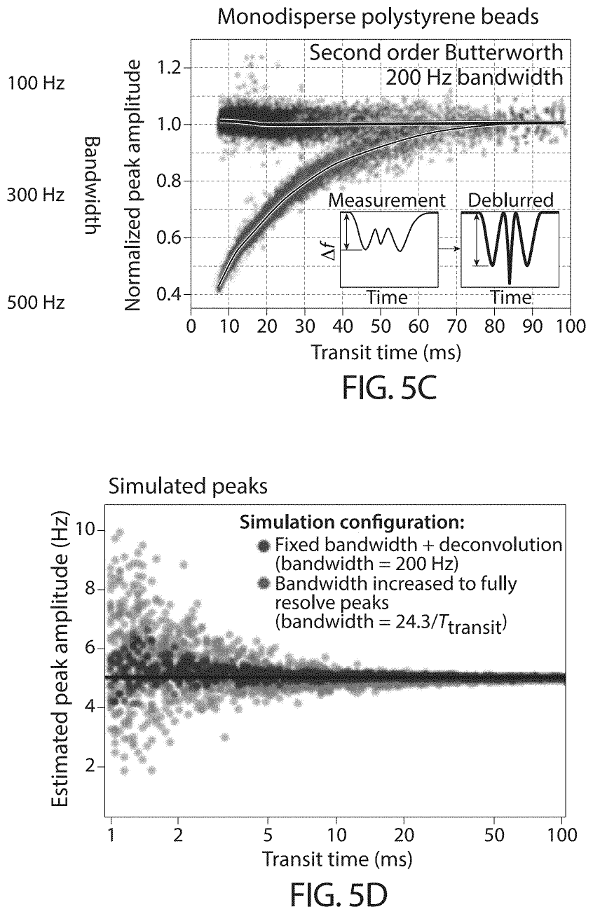

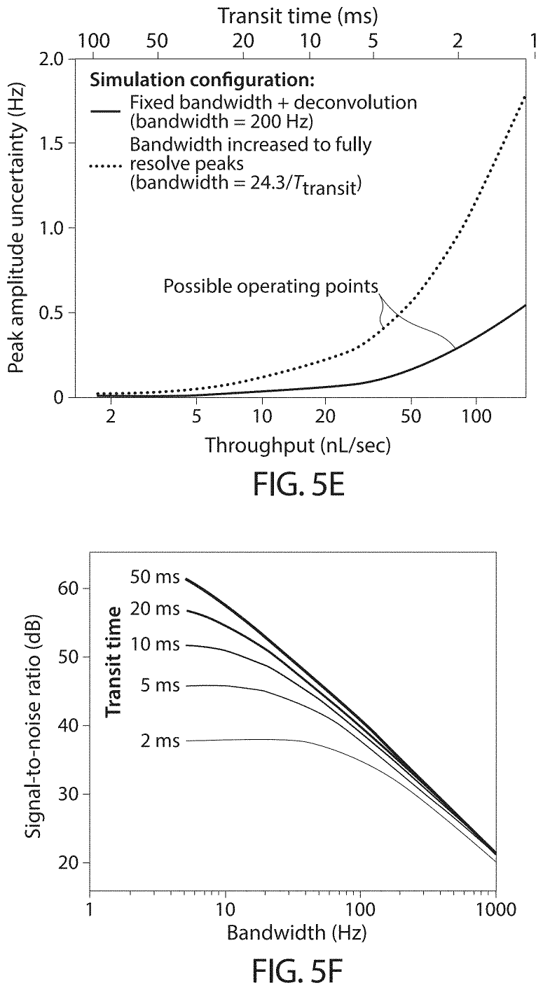

This approach relies on a linear model of the resonance-tracking dynamics of the SMR-PLL loop, i.e., that the observed distorted peak shapes are accurately modeled as a convolution of the theoretical peak shape with the resonance-tracking impulse response. To test this assumption experimentally, a sample was flowed of a nominal 1.1 μm polystyrene particles (Thermo Scientific 4000 Series) at multiple speeds (transit times of approximately 5, 10, and 20 ms) through an SMR with channel dimensions 3×5×120 μm³ while the resonance-tracking loop was configured with a first-order transfer function with one of several bandwidths (100, 300, or 500 Hz). Good agreement between the measured peak shapes and the blurred peak shapes fit by the deconvolution algorithm were observed across the grid of transit times and loop bandwidths (e.g., FIG. 5A), suggesting that a linear model accurately predicts the distortion of fast resonance frequency shifts by the SMR-PLL resonance-tracking loop.

### Accuracy and Precision

After confirming that a linear model accurately predicts distorted peak shapes, it was next asked whether applying the model-based deconvolution algorithm to measured distorted peak shapes could accurately estimate particle mass. Although the true, non-distorted resonance frequency signal is not available for measurement, the performance of this approach can be evaluated by measuring particles of the same size at different speeds, and then confirming that after the deconvolution algorithm has been applied, the estimated mass does not depend on the particle's transit time. The resonance-tracking loop was configured with a first-order transfer function of 200 Hz bandwidth, and then flowed monodisperse 1.1 μm polystyrene particles (nominal volume coefficient of variation 3.3%) through the 3×5×120 μm³ cantilever with transit times ranging from 5-100 ms (N=7685 particles; FIG. 5B). As expected, the amplitude of the measured peak shapes varied with transit time due to distortion, even though all particles had approximately the same mass. In particular, peak amplitude was attenuated for particles with transit times faster than approximately 90 ms, with more attenuation for faster-flowing particles (e.g., FIG. 5C). However, applying the deconvolution algorithm to these peaks accurately recovered the true peak amplitude; the recovered peak amplitude was approximately independent of transit time (e.g., FIG. 5C), confirming that the deconvolution algorithm accurately recovered the mass of particles with transit times as low as 7.5 ms. As a measure of the bias introduced by the deconvolution algorithm, the maximum absolute deviation of the LOESS fit (blue, solid line) from the true mean peak amplitude was 2.5%. However, these measurements only provide an upper bound on the uncertainty introduced by the deconvolution algorithm; since the measured size dispersity is approximately constant across the range of transit times, the degradation of precision introduced by deconvolution is less than the true size dispersity of the particles, which have a nominal volume coefficient of variation of 3.3%.

Next, simulations were turned to better quantify the effect of the signal recovery algorithm on measurement precision. Noisy, distorted peak shapes with 5 Hz amplitude and transit times ranging from 1-100 ms were simulated. The distorted peaks were simulated by convolving the theoretical peak shape with a resonance-tracking impulse response of interest (here, a 200 Hz second-order Butterworth impulse response), downsampling this distorted resonance frequency signal to 12.5 kHz to simulate measurement and data acquisition through the digital SMR-PLL loop, then adding white noise (σ=0.25 Hz at 200 Hz bandwidth). The deconvolution algorithm was then applied to each of these simulated distorted, noisy peak signals, and recorded the amplitudes of the recovered “de-blurred” peaks (e.g., FIG. 5D). As expected, the resulting peak amplitude estimates were symmetrically distributed about the true value of 5 Hz, with larger uncertainty for faster-flowing particles.

The performance of the deconvolution algorithm was compared to the alternative approach of simply widening the resonance-tracking bandwidth to fully resolve each particle's resonance frequency signal. To maximize precision in this measurement configuration, the resonance-tracking bandwidth should be as narrow as possible while still fully resolving the signal; for a first-order loop, the minimum bandwidth is approximately 24.3/Tₜᵣₐₙₛᵢₜ to ensure >99.9% energy recovery. To evaluate the precision of this approach, peak measurements of 5 Hz amplitude were simulated with transit times ranging from 1-100 ms, but with the loop bandwidth for each peak set to 24.3/Tₜᵣₐₙₛᵢₜ to ensure that all peak shapes were fully resolved. Each peak was corrupted with white noise appropriate to the loop bandwidth; the spectrum was assumed to be white with power increasing proportional to resonance-tracking bandwidth, with a =0.25 Hz at 200 Hz bandwidth.

Across the entire range of transit times (1-100 ms), the deconvolution algorithm achieved better precision than the alternative approach of widening the loop bandwidth to fully resolve the peak shape (e.g., FIG. 5E); for 1 ms peaks, the deconvolution-based approach improved precision by more than three-fold with this configuration and noise spectrum. In summary, the deconvolution approach allows accurate, precise mass measurements to be made on particles flowing up to 16 times faster than previously possible at a particular resonance-tracking bandwidth (Table 1), and improves precision beyond the alternative approach of increasing resonance-tracking bandwidth to fully resolve particles flowing at these higher speeds.

TABLE 1
SMR throughput comparison, for cantilevers of channel dimensions
12 × 20 × 350 μm³

| | Minimum | | |
|---|---|---|---|
| | transit | Maximum | Fold |
| System | time | throughput | improvement |
| Single SMR | 49 ms | 0.3 μL/min | 1x |
| Single SMR, deconvolution | 3 ms | 4.9 μL/min | 16x |
| Parallel SMR array | 10.6 ms | 8.1 μL/min | 27x |
| Parallel SMR array, | 3 ms | 59 μL/min | 197x |
| deconvolution (estimated) | | | |

### Optimal Bandwidth

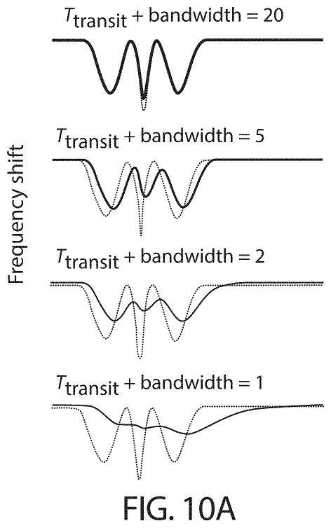

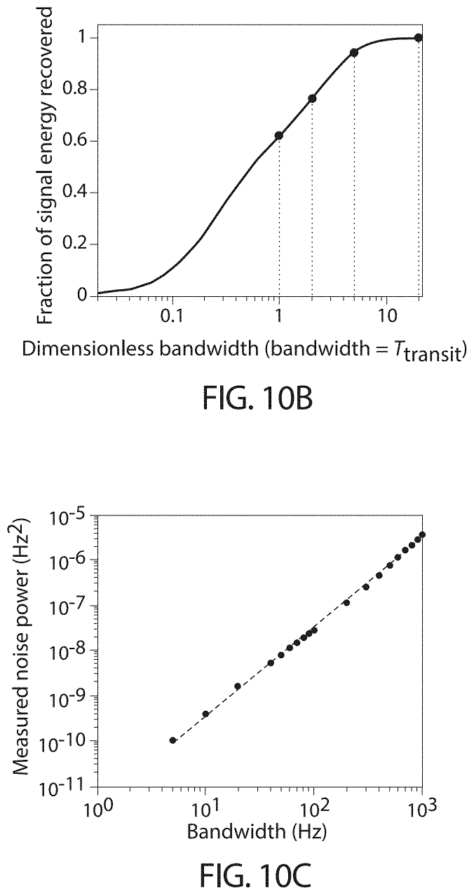

After determining that the deconvolution algorithm allows particles to be measured up to 16× faster at a particular resonance-tracking bandwidth, it was next asked how the resonance-tracking bandwidth should be selected to optimize the tradeoff between signal tracking and noise rejection for particles flowing at a particular speed. In particular, narrower loop bandwidths (of order 1/Tₜᵣₐₙₛᵢₜ) result in lower noise at the expense of more significant signal distortion, while wider loop bandwidths (>>1/Tₜᵣₐₙₛᵢₜ) result in improved temporal resolution at the expense of increased frequency noise. To quantify the tradeoff between these two objectives, the signal-to-noise ratio of measured peaks was calculated as a function of resonance-tracking bandwidth. First, signal tracking was calculated as a function of resonance-tracking loop bandwidth by calculating the recovered energy of the blurred signal as a function of resonance-tracking bandwidth and transit time. (e.g., FIG. 10A); greater energy recovery corresponds to better tracking of the resonance frequency signal. Next, frequency noise was quantified as a function of bandwidth by recording noise samples from an SMR configured with a range of resonance- tracking bandwidths, and from these noise samples calculated total noise power as a function of bandwidth (e.g., FIG. 10B). Taking the ratio of signal energy to noise power, it was observed that for our exemplary devices, the signal-to-noise ratio decreases monotonically with bandwidth for particles with a particular transit time, i.e., using narrower loop bandwidths increases the signal-to-noise ratio, with diminishing returns at very narrow loop bandwidths (e.g., FIG. 5F). This result provides additional support for the notion that when measuring particles with a particular transit time, better signal-to-noise ratios are obtained by configuring the resonance-tracking loop with a narrow bandwidth and applying the deconvolution algorithm, rather than simply widening the bandwidth to fully resolve the signal. The ideal resonance-tracking transfer function has as narrow a bandwidth as possible while still tracking the signal well enough for the deconvolution algorithm to succeed. The simulations have shown that the algorithm begins to fail (by beginning to fit incorrect peak shapes) when the dimensionless transit time Tₜᵣₐₙₛᵢₜ×bandwidth (Hz) falls below approximately 1.5.

### EXAMPLE 2

The following example describes the fabrication of parallel SMR arrays.

### Parallel SMR Arrays

Next, it was explored to what extent throughput could be increased by operating multiple SMRs simultaneously on the same microfluidic chip. Previously, it has been shown that the detection approach can be used to track multiple resonances simultaneously, whether those resonances are multiple vibrational modes of a single cantilever or multiple cantilevers with different resonance frequencies. Due to the high quality factors of the resonators, a single actuation channel and single detection channel summing the piezoresistor currents can be used to drive multiple SMRs at resonance simultaneously with minimal crosstalk.

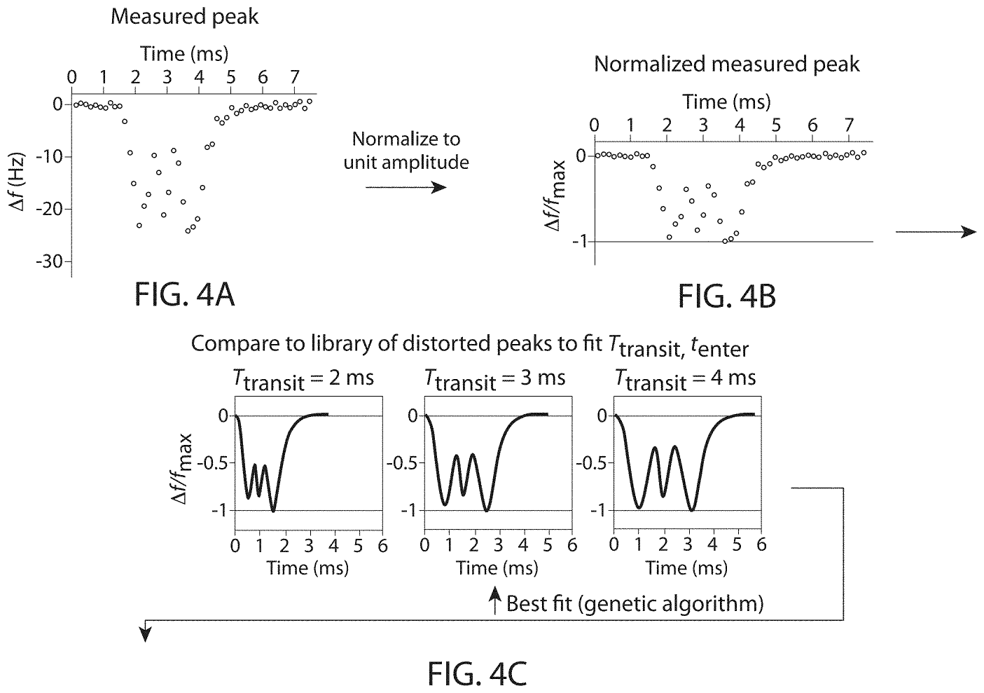

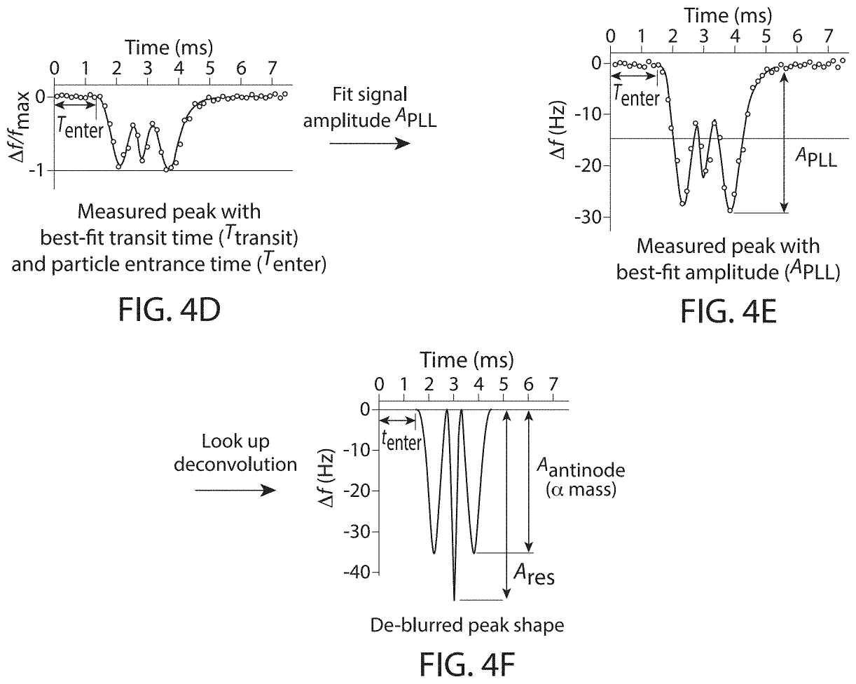

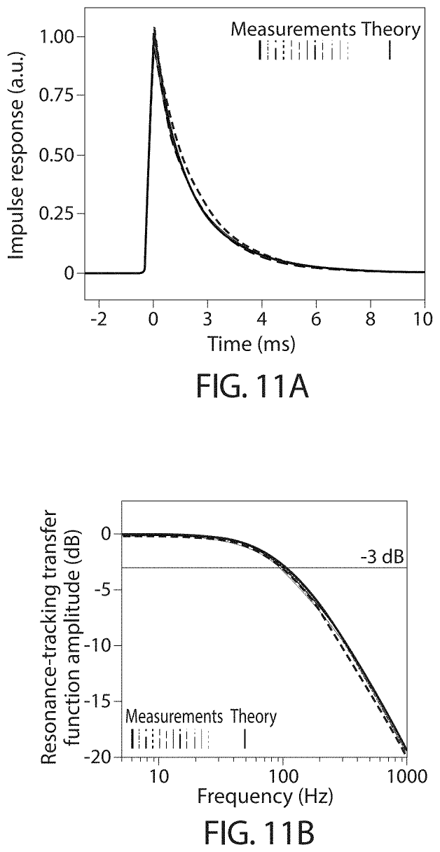

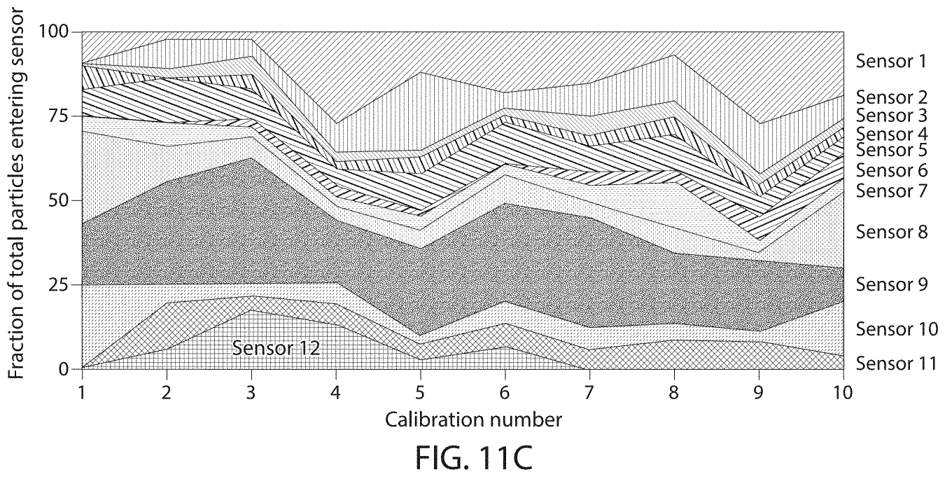

Devices containing sixteen SMRs connected fluidically in parallel between two large bypass channels (e.g., FIG. 4A) were designed. Particles are loaded into the device through the first bypass channel, pass through one of the sixteen cantilevers, then are flushed off the chip in the opposite bypass channel. Cantilever deflections are read out via embedded piezoresistors, as described previously. The fluidic channels embedded in the cantilevers have cross-sectional area 12×20 μm² and the cantilever lengths vary from 461-573 μm, resulting in second-mode resonance frequencies in the range of 600 kHz-1 MHz, with typical quality factors in the range of 2000-4000 (e.g., FIG. 6B). Of note, these devices are larger (and therefore less sensitive) than the 3×5×120 μm₃ channels described above. Either 10 or 12 of the 16 sensors were operated simultaneously to maintain compatibility with existing readout electronics. It was confirmed that each SMR-PLL resonance-tracking loop was configured with the desired dynamics by directly measuring the resonance-tracking impulse response for each SMR-PLL loop (FIG. 11A), and from this, derived the corresponding resonance-tracking transfer functions (e.g., FIG. 11B).

Pressure-driven flow is used to load particles from both ends of the bypass channel simultaneously for measurement. This sample-loading approach results in similar numbers of particles being loaded into each cantilever; however, an observed slight day-to-day drift in the fraction of particles entering each sensor was observed, even when the device is configured with nominally the same pressure settings (e.g., FIG. 11C).

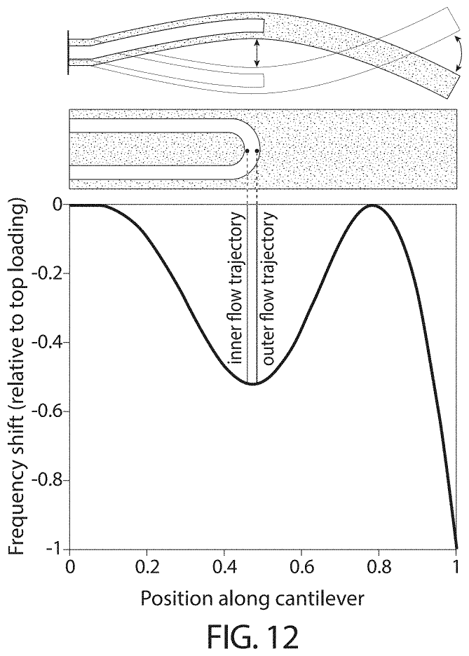

The fluidic channels inside the cantilevers were designed to extend only to the antinode when driven resonance frequency signal with a single peak, compared to the signal with three peaks when the fluidic channel extends to the tip of the cantilever (e.g. FIG. 12). This design has several advantages. First, the transient resonance frequency signal can be fully resolved (e.g., >99.9% energy recovery, with no need for deblurring) for particles flowing at ˜2.3 times higher speeds, since spectral energy of the modified peak shape is concentrated at lower frequencies. Second, since the fluid volume inside each cantilever is reduced, the system can measure more concentrated particle suspensions (by a factor of ˜2.0) without instances of two particles occupying a cantilever at the same time. Finally, compared to operating SMRs in the first mode, this approach eliminates position-dependent error resulting from variation in the trajectory a particle takes when flowing through the cantilever (e.g., FIG. 12). However, as a tradeoff, it was found that the modified peak shapes generated by these cantilevers cannot be reliably de-blurred by the model-based deconvolution algorithm, since the peak shapes do not contain enough features to reliably determine the particle's transit time and fit a distorted peak shape.

### EXAMPLE 3

The following example describes determination of the throughput, according to systems and methods described above.

### Throughput

The maximum throughput that could be achieved using the parallel SMR arrays while still precisely measuring particle masses was evaluated. The standard criterion is to require that the peak shape be fully resolved (i.e., >99.9% energy recovery); for a resonance-tracking loop with second-order Butterworth dynamics, this requires that the dimensionless transit time (Ttransit×bandwidth) be least 5.3.

At 500 Hz bandwidth, this corresponds to a minimum transit time of 10.6 ms and a maximum throughput of 8.1 μL/min through 12 cantilevers, representing a 27-fold improvement over a single SMR with the same resonance-tracking transfer function (Table 1). As an additional criterion for determining the maximum throughput, the measured peak amplitude that was required should be attenuated by no more than (say) 1% from the true value (e.g., FIG. 5C); however, this constraint was less restrictive, only requiring that the dimensionless transit time be greater than 2.6. To summarize, the designed parallel SMR arrays increase throughput by a factor of up to 27 compared to a single SMR operating with the same resonance- tracking bandwidth.

Although the peak shapes from these devices are not compatible with the model-based deconvolution algorithm, future device designs could include fluidic channels extending the full length of the cantilever, enabling the use of the deconvolution approach for even further increases in throughput. Based on the algorithm's approach for single-cantilever SMR devices, i.e., accurately recovering signal amplitude for dimensionless transit times Tₜᵣₐₙₛᵢₜ×bandwidth as low as 1.5, it was estimated that future parallel SMR arrays could achieve throughput as high as 59 μL/min through 12 cantilevers, a 197-fold improvement over previously-described single-cantilever SMRs, and a further 7-fold improvement over the current generation of parallel SMR arrays (Table 1).

Regardless of flow rate, without wishing to be bound by theory, the maximum allowable concentration of the particle suspension may be limited by the restriction that only one particle can occupy each cantilever at a time. The probability of double-occupancy events—instances where two particles occupy a cantilever at the same time—were modeled as a function of sample concentration, modeling particle loading as a Poisson process. In particular, limiting the likelihood of double-occupancy events to <10% requires that the average sample concentration be less than one particle per ˜10 cantilever volumes. For the parallel SMR arrays, this requirement limits the maximum particle concentration to approximately 850 particles/μL. At this concentration, the parallel SMR array can achieve a throughput of ˜6800 particles/minute through 12 sensors, a 55-fold improvement compared to a single SMR operating with the same resonance-tracking bandwidth (Table 1). Further, parallel SMR arrays compatible with deconvolution, this concentration corresponds to an estimated throughput of 24,000 particles/min.

### EXAMPLE 4

The following example describes the determination of particle size of a plurality of particles.

### Particle-Sizing Precision

The precision of the parallel SMR array was compared to that of a high-end commercial Coulter counter (Multisizer 4, Beckman Coulter). Specifically, the instruments' ability to resolve the size distributions of monodisperse 8, 9, and 10 μm diameter NIST-traceable polystyrene particles (Thermo Scientific 4000 Series) was compared. The Multisizer 4 was configured either with a standard 100 μm aperture (e.g., FIG. 7A) or high-sensitivity 30 μm aperture (e.g., FIG. 7B). The parallel SMR array was configured with second-order Butterworth dynamics with 500 Hz bandwidth. At least 1000 particles of each size were measured using each instrument, and calculated the robust coefficient of variation (0.741×interquartile range/median) as a measure of precision.

The 8, 9, and 10 μm diameter particles have manufacturer-reported volume coefficients of variation (CVs) of 3.3%, 3.0%, and 2.7% respectively, as determined by microscopy (e.g., FIG. 7C). The parallel SMR array resolved narrower size distributions for all particle sizes (2.0%, 1.8%, and 1.3% for the 6, 7, and 8 μm sizes respectively), suggesting that it achieves higher relative precision than the approach used by the manufacturer. The Coulter counter measured slightly broader size distributions than the SMR when configured with the high-sensitivity 30 μm aperture (4.0%, 3.3%, and 4.1%), and even wider particle size distributions with the standard 100 μm aperture (6.5%, 7.4%, and 5.0%). Still, the Coulter counter has the advantage of achieving throughput still an order of magnitude greater than the current implementation of the parallel SMR array, on the order of tens of thousands of particles per minute. Selecting the appropriate instrument still depends on the desired tradeoff between throughput and precision, and whether measuring particle mass or volume happens to be preferable for the specific application.

Although these measurements are not sufficient to determine how much of the measured size variation results from true differences in particle size as opposed to random measurement error from each instrument, they do indicate that SMRs offer improved resolution over other particle sizing techniques, which may prove useful in detecting subtle size changes or the existence of subpopulations in heterogeneous samples.

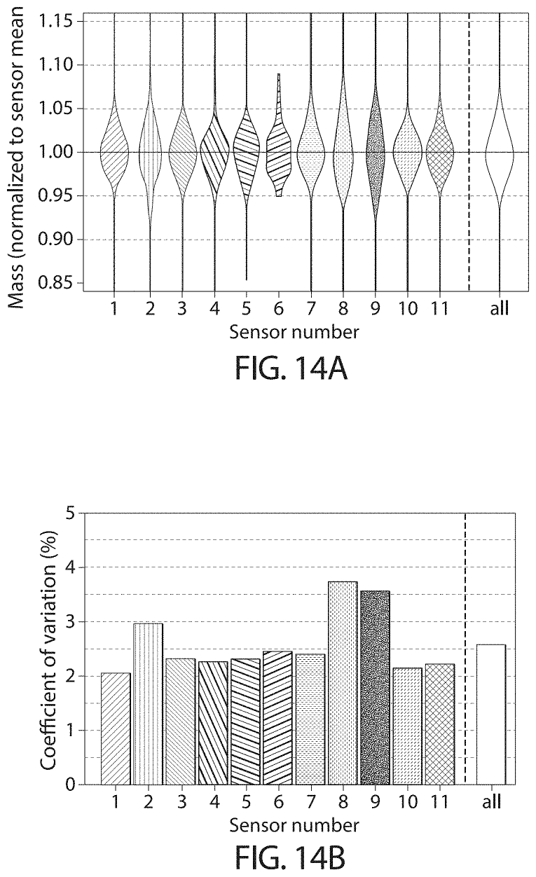

To identify whether there were significant differences in precision between individual sensors in the parallel SMR array, a sample of 8 micron polystyrene beads was measured and compared the size distributions measured in each cantilever (FIG. 14). The coefficients of variation for each cantilever (ranging from 2.1-3.7%) were comparable to the overall coefficient of variation (2.6%).

In some embodiments, the parallel SMR arrays designed with full-length fluidic channels for compatibility with the deconvolution algorithm could achieve throughput as high as 59 μL/min, a 197-fold improvement compared to existing systems, and a further 7-fold improvement over the parallel SMR arrays described here.

While some embodiments may use at least 16 SMRs, for some embodiments, larger arrays of SMRs (e.g. >16 SMRs) may be designed with more than the sixteen sensors. In certain embodiments, at least 18 SMRs, at least 20 SMRS, at least 25 SMRs, or at least 30 SMRs may be used in an array. In such embodiments, the SMRs may be fluidically in parallel and in fluid communication with an inlet. However, several factors may limit the maximum number of sensors that can be operated on the same chip. One of the primary limitations is the requirement to space out the resonances in the frequency domain to avoid mechanical or electrical coupling between sensors. For example, it was observed that coupling between sensors and SMRs when the resonance frequencies are spaced much closer than ˜25 kHz. Therefore, adding more sensors requires that the cantilevers be designed with resonance frequencies distributed over a wider range, i.e., for 50 cantilevers the resonances must be distributed over a range of >1.2 MHz to achieve a minimum 25 kHz spacing.

### EXAMPLE 5

The following example describes providing maximum particle concentration to avoid multiple occupancy events.

Regardless of volumetric flow rate, the maximum particle concentration that can be measured is limited by the fact that at high sample concentrations, multiple particles will occupy a cantilever at the same time, and the resulting resonance frequency signal is the sum of the two individual peak shapes. While it is possible to decouple these signals, it is useful to limit the particle concentration to avoid the need to employ these techniques. The frequency of double-occupancy events—events where two particles occupy the cantilever simultaneously—was estimated as a function of particle concentration.

Modeling the loading of particles into cantilevers as a Poisson process, the distribution of times between successive particles entering the cantilever is exponential, with density

$$f ( t ; {T}_{mean} ) = ( \frac{1}{{T}_{mean}} ) {e}^{- t / {T}_{mean}} \qquad ( 5 )$$

A double-occupancy event occurs when the separation between consecutive particles is less than the transit time. This occurs with probability

P(double occupancy)=∫_{t′=0}^{t′=T}^{ₜᵣₐₙₛᵢₜ}f(t′; Tₘₑₐₙ)dt′=1−e^{-T}^{ₜᵣₐₙₛᵢₜ}^{/T}^{ₘₑₐₙ} (6)

The mean particle spacing Tₘₑₐₙ can be expressed in terms of the sample concentration (cₒ) and volumetric flow rate (Q) by noting that the flux of particles through the sensor is given by (equivalently)

1/Tₘₑₐₙ=c₀Q (7)

Finally, the volumetric flow rate is related to the sensor volume and particle transit time, Q=Vₛₑₙₛₒᵣ/Tₜᵣₐₙₛᵢₜ under the approximation that particles travel at the mean flow velocity. Collecting these terms, the probability of a double occupancy event is

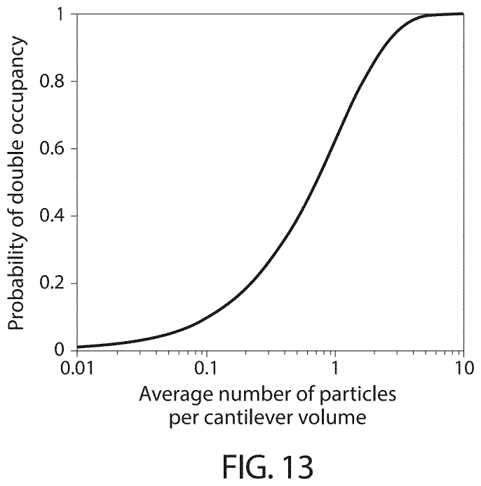

P(double occupancy)=1−e^{-c}^{ₒ}^{V}^{ₛₑₙₛₒᵣ} (8)

where the quantity cₒvₛₑₙₛₒᵣ is a dimensionless concentration corresponding to the average number of particles per cantilever volume (e.g., FIG. 13). Therefore, to limit the probability of doubleoccupancy events to be no greater than p, the average number of particles per cantilever volume should be, in some cases, less than ln(1/(1−p)). In some cases, the probability of double occupancy events was limited to p<0.1, requiring that on average there be no more than ˜0.1 particles per cantilever volume, or 1 particle per 10 cantilever volumes (e.g., FIG. 14).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Any terms as used herein related to shape, orientation, alignment, and/or geometric relationship of or between, for example, one or more droplets, components, combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, alignment, and/or geometric relationship include, but are not limited to terms descriptive of: shape—such as, round, square, circular/circle, rectangular/rectangle, triangular/triangle, cylindrical/cylinder, elipitical/elipse, (n)polygonal/(n)polygon, U-shaped, line-shaped, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; arrangement—array, row, column, etc. As one example, a fabricated article that would described herein as being “ square” would not require such article to have faces or sides that are perfectly planar or linear and that intersect at angles of exactly 90 degrees (indeed, such an article can only exist as a mathematical abstraction), but rather, the shape of such article should be interpreted as approximating a “ square,” as defined mathematically, to an extent typically achievable and achieved for the recited fabrication technique as would be understood by those skilled in the art or as specifically described. As another example, a plurality of droplets that would be described herein as being in an “array” would not require such droplets to have centers that are perfectly arranged in row and columns in which all major axes of the droplets are aligned (indeed, such an array can only exist as a mathematical abstraction), but rather, the arrangement of such droplets should be interpreted as approximating an “array”, as defined mathematically, to an extent typically achievable and achieved for the recited fabrication technique as would be understood by those skilled in the art or as specifically described.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A fluidic system, comprising:
an inlet;
a plurality of suspended microchannel resonators each comprising a fluidic channel connected fluidically in parallel and in fluidic communication with the inlet;
an excitation element for driving one or more of the suspended microchannel resonators;
a sensor associated with the plurality of suspended microchannel resonators, wherein the plurality of suspended microchannel resonators is configured to be operated essentially simultaneously.

2. A method of determining a property of a particle, comprising:
flowing the particle in a device comprising a suspended microchannel resonator, the suspended microchannel resonator comprising a microfluidic channel configured to receive the plurality of particles;
driving the suspended microchannel resonators with an excitation element;
sensing a resonance frequency of the suspended microchannel resonators as the particle flows in the microfluidic channel; and
modifying the resonance frequency of the suspend microchannel resonator to determine the property of the particle.

3. A fluidic system as in claim 1, wherein the fluidic channel has a cross-sectional dimension of greater than or equal to 1 micron and less than or equal to 2 mm.

4. A method as in claim 2, wherein the particle is suspended in a fluid.

5. A fluidic system as in claim 1, wherein the plurality of suspended microchannel resonators has a throughput of greater than or equal to 6,800 particles/min and less than or equal to 24,000 particles/min.

6. A method as in claim 2, wherein the suspended microchannel resonator has a throughput of greater than or equal to 6,800 particles/min and less than or equal to 24,000 particles/min.

7. A fluidic system, comprising:
an inlet;
a plurality of suspended microchannel resonators each comprising a fluidic channel connected fluidically in parallel and in fluidic communication with the inlet;
an excitation element for driving one or more of the suspended microchannel resonators;
a sensor associated with the plurality of suspended microchannel resonators,
wherein the plurality of suspended microchannel resonators has a throughput of at least 1,000 particles/min.

8. A fluidic system as in claim 7, wherein the plurality of suspended microchannel resonators has a throughput of at least 6,800 particles/min

9. A fluidic system as in claim 7, wherein the plurality of suspended microchannel resonators has a throughput of at least 24,000 particles/min.

10. A fluidic system as in claim 7, wherein the plurality of suspended microchannel resonators has a throughput of at least 60,000 particles/min.

11. A fluidic system as in claim 7, wherein the plurality of suspended microchannel resonators has a throughput of at least 84,000 particles/min.

12. A fluidic system as in claim 7, wherein the plurality of suspended microchannel resonators has a throughput no greater than 100,000 particles/min.

13. A fluidic system as in claim 7, wherein the plurality of suspended microchannel resonators has a throughput no greater than 84,000 particles/min.

14. A fluidic system as in claim 7, wherein the plurality of suspended microchannel resonators has a throughput no greater than 24,000 particles/min.

15. The method of claim 2, wherein the method comprises comparing the resonance frequency to a pre-computed resonance frequency.

16. The method of claim 2, wherein the method comprises deconvoluting the resonance frequency.

17. The method of claim 2, wherein the method further comprises preventing double occupancy of by the particle in the microfluidic channel during the driving and/or the sensing step.

18. The fluidic system of claim 7, wherein the fluidic channel has a length extending to an anti-node location of suspended microchannel resonator.

19. The method of claim 2, wherein the microfluidic channel has a length extending to an anti-node location of the suspended microchannel resonator.
